(19) United States
(12) Patent Application Publication
(10) Pub. No.: US 2008/0320544 A1
(43) Pub. Date: Dec. 25, 2008

(54) HARDWARE-IMPLEMENTED VIDEO BROADCASTING RECEIVER

(75) Inventors: Neeraj Kashalkar, Irvine, CA (US); Christopher den Haan, Burnaby (CA); Hongfan Wang, Lake Forest, CA (US); Sushil Kering, Pune (IN); Stephen A. Mueller, Foothill Ranch, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 12/124,931

(22) Filed: May 21, 2008

Related U.S. Application Data
(60) Provisional application No. 60/946,073, filed on Jun. 25, 2007.

(51) Int. Cl. H04N 7/173

(52) U.S. Cl. 725/131

(57) ABSTRACT

A hardware-implemented video broadcasting receiver is described. The hardware-implemented video broadcasting receiver includes a radio frequency (RF) tuner, a demodulator connected to the RF tuner, link layer logic connected to the demodulator, and a power manager connected to the RF tuner, the demodulator and the link layer logic. The power manager is configured to receive delta-T values extracted from a transport stream by the link layer logic, to determine whether each of the RF tuner, the demodulator and the link layer logic can be powered down based on the delta-T values, and to power down the RF tuner, the demodulator and the link layer logic based on the determination, thereby reducing the average power consumed by the video broadcasting receiver.

### CROSS-REFERENCE TO RELATED APPLICATIONS

This application claims priority to Provisional U.S. Patent Application No. 60/946,073, entitled “Hardware-Implemented Link Layer Architecture for a Mobile TV System on Chip,” filed Jun. 25, 2007, the entirety of which is incorporated by reference herein.

### BACKGROUND OF THE INVENTION

1. Field of the Invention

The present invention generally relates to video broadcasting receivers, including but not limited to DVB-H (Digital Video Broadcasting—Handheld) receivers.

2. Background

DVB-H is a technical specification for bringing broadcast services to handheld devices. DVB-H may be considered a superset of the DVB-T (Digital Video Broadcasting—Terrestrial) specification for digital terrestrial television, with additional features to meet the specific requirements of handheld, battery-powered terminals. DVB-H was formally adopted in November of 2004 as ETSI standard EN 302 304 (referred to herein as “the DVB-H standard”), the entirety of which is incorporated by reference as if fully set forth herein.

The DVB-H standard employs a technique called “time slicing.” Time slicing consists of sending data in bursts using a significantly higher instantaneous bit rate compared to the bit rate required if the data were transmitted using traditional streaming mechanisms. To indicate to a DVB-H receiver when to expect the next burst, the time to the beginning of the next burst (“delta-T”) is indicated within the burst currently being received. Between the bursts, data associated with the elementary stream(s) included in the bursts is not transmitted, allowing other elementary streams to share the capacity otherwise allocated.

A DVB-H receiver may be configured to take advantage of time slicing by powering down various receiver components during time periods when no bursts associated with requested services are expected. This will reduce the average power consumption of the DVB-H receiver, which is highly desirable for handheld devices that operate on a limited power source such as a battery.

However, the manner in which such power management functionality is implemented will affect how much power is actually conserved. For example, DVB-H receivers that use software to determine when one or more receiver components can be powered down may consume a substantial number of processing cycles to make this determination. This may be particularly true where the DVB-H receiver is required to track the arrival and processing of bursts associated with many different services. The effect of this processing will be to reduce the actual amount of time that the receiver components can be powered down, since the processing necessarily occurs after the required conditions for power down have already arisen.

What is needed then is a power management system and method for a video broadcasting receiver, such as a DVB-H receiver, that maximizes the amount of time that components of the receiver may be powered down. Among other features, the desired system and method should reduce the amount of time needed to determine when receiver components may be powered down or must be powered up, as well as the amount of time necessary to actually power down or power up such components.

### BRIEF SUMMARY OF THE INVENTION

A hardware-implemented video broadcasting receiver, such as a DVB-H receiver, is described herein that includes power management features for reducing the amount of time needed to determine when one or more receiver components may be powered down or must be powered up, as well as the amount of time necessary to actually power down or power up such components. A hardware-implemented video broadcasting receiver in accordance with an embodiment of the present invention can thus advantageously achieve reduced average power consumption.

In particular, a hardware-implemented video broadcasting receiver is described herein. The hardware-implemented video broadcasting receiver includes a radio frequency (RF) tuner, a demodulator connected to the RF tuner, link layer logic connected to the demodulator, and a power manager connected to the RF tuner, the demodulator and the link layer logic. The RF tuner is configured to receive bursts of RF signals and to convert the RF signals into in-phase (I) and quadrature (Q) signal components. The demodulator is configured to convert the I and Q signal components into a transport stream. The link layer logic is configured to generate a series of Internet Protocol (IP) packets from the transport stream and to extract delta-T values therefrom, each delta-T value being representative of an amount of time from a beginning of a section carried by the transport stream to receipt of a next burst by the video broadcasting receiver. The power manager is configured to receive the delta-T values from the link layer logic, to determine whether each of the RF tuner, the demodulator and the link layer logic can be powered down based on the delta-T values, and to power down the RF tuner, the demodulator and the link layer logic based on the determination.

The power manager may be configured to power down the RF tuner, the demodulator and the link layer logic by transmitting respective power down signals to the RF tuner, the demodulator and the link layer logic. Alternatively, the power manager may be configured to power down the RF tuner, the demodulator and the link layer logic by generating interrupts to a host processor, wherein the host processor is configured to power down the RF tuner, the demodulator and the link layer logic responsive to receiving the interrupts.

The link layer logic may include a plurality of sub-blocks and the power manager may be configured to power down the link layer logic by gating a respective clock signal to each sub-block in the plurality of sub-blocks. The power manager may be configured to gate a respective clock signal to each sub-block in the plurality of sub-blocks responsive to sending a respective power down request signal to each sub-block in the plurality of sub-blocks and subsequently receiving a respective power down ready signal from each sub-block in the plurality of sub-blocks.

The power manager may be configured to store a respective delta-T value for each service in a plurality of services and to determine whether each of the RF tuner, the demodulator and the link layer logic can be powered down by determining, for each service in the plurality of services, if an amount of time that has elapsed since receiving the delta-T value for the service is less than an amount of time represented by the delta-T for the service less a minimum sleep time.

The power manager may also be configured to determine whether the link layer logic is processing any frames carried by the transport stream and associated with a requested service and to determine whether each of the RF tuner, the demodulator and the link layer logic can be powered down responsive to determining that the link layer logic is not processing any frames carried by the transport stream and associated with a requested service. The power manager may be configured to determine whether the link layer logic is processing any frames carried by the transport stream and associated with a requested service by monitoring signals from the link layer logic indicating that an end of a frame has been received or that an end of an application data table portion of a frame has been received. The power manager may also be configured to determine whether the link layer logic is processing any frames carried by the transport stream and associated with a requested service by monitoring whether a maximum burst duration associated with a frame currently being processed by the link layer logic has been exceeded.

The power manager may be further configured to determine when each of the RF tuner, the demodulator and the link layer logic should be powered up based on the delta-T values. For example, the power manager may be configured to store a respective delta-T value for each service in a plurality of services and to determine when each of the RF tuner, the demodulator or the link layer logic should be powered up by determining, for each service in the plurality of services, if an amount of time that has elapsed since receiving the delta-T value for the service is less than an amount of time represented by the delta-T value for the service less an offset time associated with the RF tuner, the demodulator, or the link layer, respectively.

The link layer logic may be configured to extract delta-T values from consecutive sections in a plurality of frames carried by the transport stream and the power manager may be configured to determine whether each of the RF tuner, the demodulator and the link layer logic can be powered down based on delta-T values respectively associated with the most-recently processed sections in each frame in the plurality of frames.

The power manager may also be configured to identify one or more services for which packets should be received within the transport stream based on the delta-T values and to transmit signals to the link layer logic that identify the one or more services. The link layer logic may further be configured to filter packets within the transport stream based on the signals transmitted from the power manager.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example DVB-H receiver in accordance with an embodiment of the present invention.

FIG. 2 is a block diagram of a transport stream packet filter in accordance with an embodiment of the present invention.

FIG. 3 is a block diagram of a section manager in accordance with an embodiment of the present invention.

FIG. 4 is a block diagram of a frame manager in accordance with an embodiment of the present invention.

FIG. 5 is a logical representation of an MPE-FEC frame.

FIG. 6 is a diagram illustrating a physical implementation of a plurality of frame buffers for storing MPE-FEC frames in accordance with an embodiment of the present invention.

FIG. 7 is a block diagram of a power manager in accordance with an embodiment of the present invention.

FIG. 8 depicts a flowchart of a method for controlling a power manager during system startup in accordance with an embodiment of the present invention.

FIG. 9 depicts a flowchart of a method for setting a maximum burst duration (MBD) timer in accordance with an embodiment of the present invention.

FIG. 10 depicts the logical structure an MBD table managed by a power manager in accordance with an embodiment of the present invention.

FIG. 11 depicts a flowchart of a method for clearing an entry within an MBD table in accordance with an embodiment of the present invention.

FIG. 12 depicts a flowchart of a method for recording a new delta-T value for a frame in accordance with an embodiment of the present invention.

FIG. 13 depicts the logical structure of a delta-T table managed by a power manager in accordance with an embodiment of the present invention.

FIG. 14 depicts a flowchart of a method for determining if certain components of a DVB-H receiver are eligible for power down in accordance with an embodiment of the present invention.

FIG. 15 depicts a flowchart of a method for determining when certain components of a DVB-H receiver should be powered up in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The present specification discloses one or more embodiments of a DVB-H receiver that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### II. DVB-H Receiver in Accordance with an Embodiment of the Present Invention

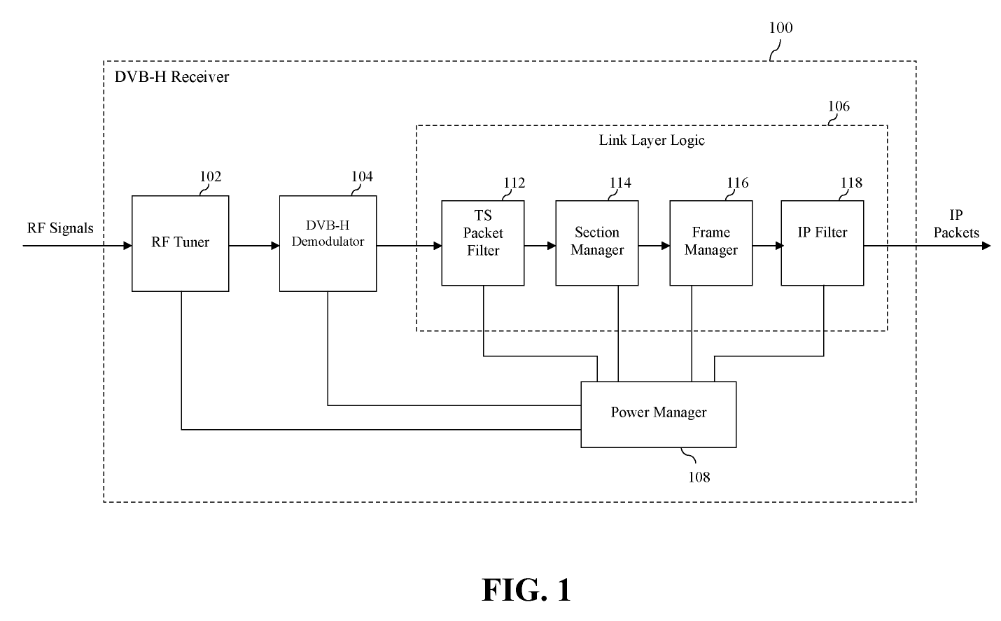

FIG. 1 is a block diagram of an example DVB-H receiver 100 in accordance with an embodiment of the present invention. As shown in FIG. 1, DVB-H receiver 100 includes a number of interconnected functional blocks including a radio frequency (RF) tuner 102, a DVB-H demodulator 104, and link layer logic 106. Link layer logic 106 includes a number of sub-blocks including a transport stream (TS) packet filter 112, a section manager 114, a frame manager 116 and an IP filter 118. As further shown in FIG. 1, a power manager 108 is connected to RF tuner 102, DVB-H demodulator 104, and to each of the sub-blocks within link layer logic 106. Each of these functional blocks is implemented in hardware using analog and/or digital circuits, although certain operating parameters of the functional blocks may be configured in software. The functional blocks may together form a part of a single integrated circuit chip.

Generally speaking, RF tuner 102, DVB-H demodulator 104 and link layer logic 106 operate together to convert RF signals received as bursts by RF tuner 102 into Internet Protocol (IP) packets representative of a video or audio/video stream for delivery to an application program. The application program may be executing on a system or device that is communicatively connected to DVB-H receiver 100 or may be executing on a system or device of which DVB-H receiver 100 is a part. The manner in which these components operate to perform this function will be discussed in more detail below.

As also will be described herein, power manager 108 operates to reduce the average power consumption of DVB-H receiver 100 by powering down RF tuner 102, DVB-H demodulator 104 and each of the sub-blocks within link layer logic 106 during time periods when no bursts associated with requested services are scheduled to be received by DVB-H receiver 100. The manner in which power manager 108 operates to perform this function will also be described in more detail below.

A. Processing of RF Bursts by DVB-H Receiver

The following provides a description of RF tuner 102, DVB-H demodulator 104 and link layer logic 106 of DVB-H receiver 100 and how such components operate together to convert RF signals received as bursts by RF tuner 102 into IP packets representative of a video or audio/video stream for delivery to an application. This description is provided by way of example only and is not intended to be limiting.

1. RF Tuner

RF tuner 102 is a functional block that is configured to detect bursts of low-amplitude RF signals carrying DVB-H video or audio/video content and to amplify and convert those signals into in-phase (I) and quadrature (Q) signal components suitable for further processing. RF tuner 102 includes integrated analog-to-digital (A/D) conversion functionality for performing this task.

2. DVB-H Demodulator

DVB-H demodulator 104 is configured to receive I and Q signal components output by RF tuner 102 and to convert these components into an MPEG-2 transport stream for delivery to TS packet filter 112 within link layer logic 106. As will be appreciated by persons skilled in the art, the MPEG-2 transport stream is comprised of a series of 188-byte transport stream packets, each of which is associated with a unique elementary stream or packet ID (PID). DVB-H demodulator 104 is also configured to perform Reed-Solomon error-correction decoding on the TS packets.

The signals output from DVB-H demodulator 104 to TS packet filter 112 in accordance with one implementation of the present invention are represented in Table 1 below.

TABLE 1
Signals Output from DVB-H Demodulator to TS Packet Filter

| Signal Name | Pins | Active |
|---|---|---|
| ts_clk | 1 | N/A |
| ts_start | 1 | High |
| ts_valid | 1 | High |
| ts_data [7:0] | 8 | N/A |
| ts_err [1:0] | 2 | N/A |

In Table 1, “signal name” identifies the name of a given signal, “pins” specifies the number of pins or wires used to carry a given signal from DVB-H demodulator 104 to TS packet filter 112, and “active” specifies (where applicable) whether a given signal is active high or active low. Similar designations will be used elsewhere herein to describe signals that are input and/or output from other functional blocks within example DVB-H receiver 100. Each of the signals in Table 1 will now be briefly described.

The signal ts_clk is a transport stream clock used by DVB-H demodulator 104 for the transmission of signals to TS packet filter 112.

The signal ts_data [7:0] is used to carry consecutive bytes in the MPEG-2 transport stream from DVB-H demodulator 104 to TS packet filter 112.

The signal ts_start is asserted to indicate the start of a transport stream packet. In particular, when ts_start goes high for one clock cycle, this indicates that the byte currently being transmitted on ts_data [7:0] is the first byte of a new transport stream packet.

The signal ts_valid is asserted to indicate that ts_data [7:0] is valid. This signal is set high for an entire 188-byte transport stream packet.

The signal ts_err [1:0] provides error information concerning the transport stream packet currently being transmitted to TS packet filter 112. Such error information is provided by a Reed-Solomon decoder within DVB-H demodulator 104. A value of “00” indicates that the transport stream packet is error-free, a value of “01” indicates that the transport stream packet has been corrected, a value of “10” indicates that the transport stream packet contains uncorrectable errors, and the value “11” is reserved. The signal ts_err [1:0] is held stable for an entire 188-byte transport stream packet.

3. TS Packet Filter

TS packet filter 112 within link layer logic 106 is configured to receive transport stream packets from DVB-H demodulator 104 and to selectively pass section data embedded in certain transport stream packets on to section manager 114 within link layer logic 106 along with associated control and status information.

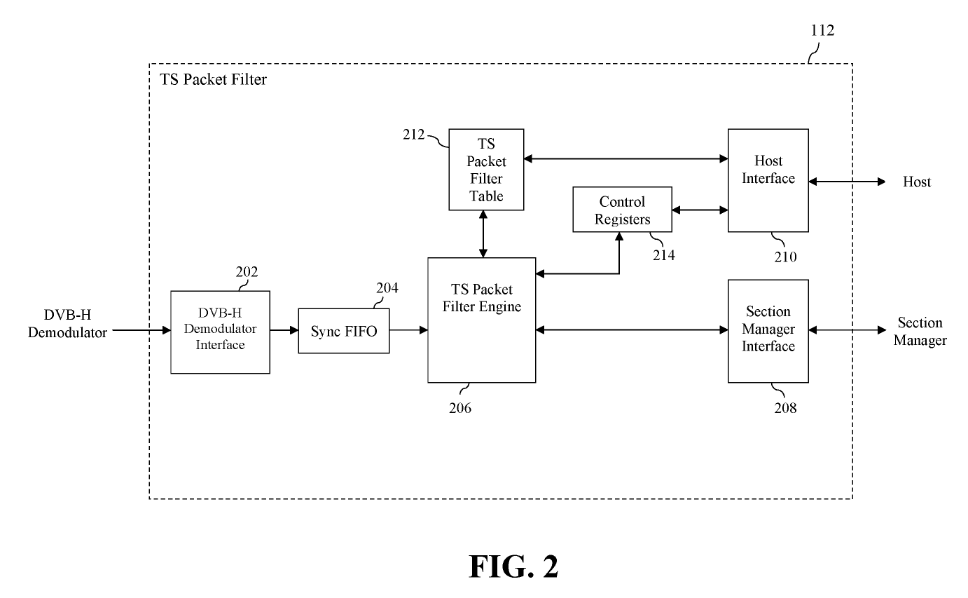

FIG. 2 is a block diagram that shows TS packet filter 112 in more detail. As shown in FIG. 2, TS packet filter 112 includes a number of interconnected logic blocks including a DVB-H demodulator interface 202, a synchronization (sync) FIFO 204, a TS packet filter engine 206, a section manager interface 208, a host interface 210, a TS packet filter table 212 and control registers 214. Each of these logic blocks will be described in more detail below.

DVB-H demodulator interface 202 is configured to receive various signals output from DVB-H demodulator 104 that were described above in reference to Table 1. In particular, DVB-H demodulator interface 202 is configured to monitor the ts_start signal from DVB-H demodulator 104 to determine when DVB-H demodulator 104 is sending a new transport stream packet. Responsive to the ts_start signal going high, DVB-H demodulator interface 202 receives an 188-byte transport stream packet from DVB-H demodulator 104 one byte at a time via ts_data [7:0] and transfers it into sync FIFO 204 when there is sufficient free space to do so. If there is insufficient free space in sync FIFO 204, then the entire transport stream packet is dropped, a counter is incremented, and an error interrupt signal is signaled to an entity external to DVB-H receiver 100.

Sync FIFO 204 provides a clock boundary between the ts_clk from DVB-H demodulator 104 and a system clock utilized by TS packet filter 112. In one implementation, sync FIFO is 1024 bytes deep and thus can hold more than 5 complete 188-byte transport stream packets.

TS packet filter engine 206 is configured to obtain transport stream packets out of sync FIFO 204. TS packet filter engine 206 is further configured to selectively pass section data embedded in certain TS packets on to section manager 206 along with associated control and status information. TS packet filter engine 206 performs this filtering function based on information obtained (1) from the header of each transport stream packet, (2) from TS packet filter table 212, and (3) from control registers 214.

An important function of TS packet filter engine 206 is to ensure that certain services that are of interest to a host are processed while those that are not are ignored. To facilitate this function, host interface 210 of TS packet filter 112 allows a host to identify up to 32 different valid PIDs in TS packet filter table 212. These PIDs may be referred to herein as “requested PIDs.” When TS packet filter engine 206 processes a transport stream packet, it determines if a PID in the header of the transport stream packet matches a valid PID stored in table 212. If the PID from the header does not match a valid PID stored in table 212, then the transport stream packet is discarded. If the PID from the header does match a valid PID stored in table 212, then the transport stream packet may be retained depending on other filtering functions performed by TS packet filter engine 206.

In one implementation, TS packet filter table 212 includes one row for each of the 32 PIDs. Each row may also include other parameters that can be used by TS packet filter engine 206 to filter transport stream packets associated with a particular PID. In contrast, control registers 214 may include global parameters that are used by TS packet filter engine 206 to filter transport stream packets regardless of which PID they are associated with. Both TS packet filter table 212 and control registers 214 are configurable via host interface 210.

If TS packet filter engine 206 determines that section data in a transport stream packet should be transmitted to section manager 114, then TS packet filter engine 206 sends the section data and associated control and status information to section manager 114 via section manager interface 208. The information is sent using the signals shown in Table 2 below. Each of these signals will now be described.

TABLE 2
Signals Output from TS Packet Filter to Section Manager

| Signal Name | Pins | Active |
|---|---|---|
| pf_data [31:0] | 32 | N/A |
| pf_byte_valid [3:0] | 4 | High |
| pf_new_section | 1 | High |
| pf_data_valid | 1 | High |
| pf_pid [12:0] | 13 | N/A |
| pf_erasure | 1 | High |
| pf_squ_ind | 1 | High |
| pf_lkup_ptr [4:0] | 5 | N/A |
| pf_cntl_val | 1 | High |

The signal pf_data [31:0] is used to carry 4 bytes of section data associated with the PID indicated by pf_pid. The data bytes are arranged in a big-endian fashion such that the first byte in a new section will be on pf_data [31:24].

The signal pf_byte_valid [3:0] is used to indicate whether each data byte in pf_data [31:0] is valid. The signals pf_byte_valid [0], [1], [2] and [3] correspond to pf_data [7:0], [15:8], [23:16] and [31:24], respectively.

The signal pf_new_section is asserted to indicate that the bytes being transferred over pf_data [31:0] are the first bytes in a new section associated with the PID indicated by pf_pid. In accordance with DVB-H data mapping conventions, a section may be spread across multiple transport stream packets such that multiple packet payloads together form a section. To address this, TS packet filter engine 206 is configured to use information provided in the transport stream packet headers to determine where one section ends and a subsequent section begins.

The signal pf_data_valid is asserted to indicate that the signals pf_data [31:0], pf_byte_valid and pf_new section are valid.

The signal pf_pid [12:0] is used to carry the 13-bit PID associated with the section data being transmitted to section manager 114.

The signal pf_erasure is used to specify the error conditions of the transport stream packet that included the section data being transmitted. When asserted, this signal indicates that the relevant transport stream packet was received from DVB-H demodulator 104 with errors. Depending upon the implementation, the determination of whether the relevant transport stream packet was received from DVB-H demodulator 104 with errors may be based on the ts_err [1:0] signal received from DVB-H demodulator 104, based on header information included in the relevant transport stream packet, or based on both.

The signal pf_squ_ind is asserted to indicate that the transport stream packet that included the section data being transmitted was received out of sequence. TS packet filter engine 206 is configured to determine whether a transport stream packet has been received out of sequence by comparing counters located in the packet headers of consecutively-received transport stream packets associated with the same PID.

The signal pf_lkup_ptr [4:0] is a pointer that indicates the position of the PID indicated by pf_pid within TS packet filter table 212. As will be described in more detail herein, this pointer is used by section manager 114 to access a similarly-organized table that is logically associated with TS packet filter table 212.

The signal pf_cntl_val is asserted to indicate to section manager 114 that the control signals pf_erasure, pf_squ_ind, pf_lkup_ptr and pf_pid should be sampled.

TS packet filter engine 206 will only send section data to section manager 114 when section manager 114 provides an indication that a buffer within section manager 114 used to hold such data is not full. The signal used to indicate this condition, sm_full, is set forth in Table 3 below.

TABLE 3
Signal Input to TS Packet Filter from Section Manager

| Signal Name | Pins | Active |
|---|---|---|
| sm_full | 1 | High |

When sm_full is asserted, the buffer within section manager 114 is full and no section data may be transmitted.

4. Section Manager

Section manager 114 is another sub-block within link layer logic 106. Among other functions, section manager 114 is configured to track the status of sections built from section data transmitted from TS packet filter 112, as well as to track the status of frames built from such sections. In particular, section manager 114 is configured to concurrently track the status of sections and frames associated with anywhere from one to eight different time slices, depending on the frame size associated with each time slice. Section manager 114 is also configured to transmit frame data, along with associated erasure information, status information and control information, to frame manager 116. This information is used by frame manager 116 to construct one to eight MPE-FEC frame(s) using one to eight frame buffers located within frame manager 116 and, when applicable, to perform error correction operations on the MPE-FEC frame(s).

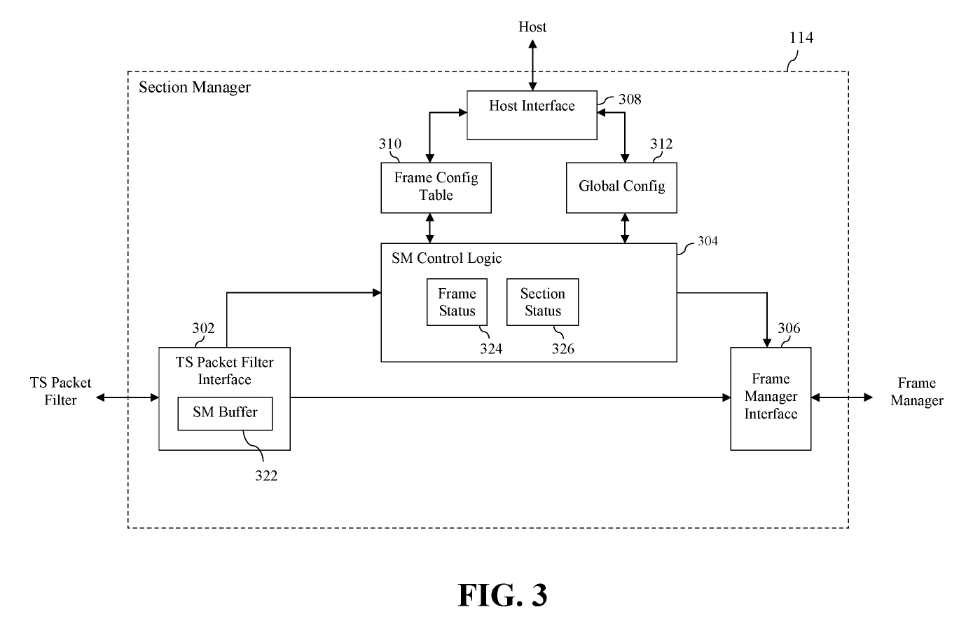

FIG. 3 is a block diagram that shows section manager 114 in more detail. As shown in FIG. 3, section manager 114 includes a number of interconnected logic blocks including a TS packet filter interface 302, SM control logic 304, a frame manager interface 306, a host interface 308, a frame configuration table 310 and a global configuration register 312. Each of these logic blocks will be described in more detail below.

TS packet filter interface 302 is configured to send and receive signals to and from TS packet filter 112. In particular, TS packet filter interface 302 is configured to receive the signals described above in reference to Table 2 from TS packet filter 112. TS packet filter interface 302 is also configured to temporarily store section data received from TS packet filter 112 in an SM buffer 322 to facilitate processing by SM control logic 304. When SM buffer 322 becomes full, TS packet filter interface 302 asserts the sm_full signal (described above in reference to Table 3), which causes TS packet filter 112 to stop transmitting section data.

SM control logic 304 is configured to perform a number of functions including tracking the building of sections and frames and controlling the transmission of frame data, erasure information, status information and control information to frame manager 116. For example, SM control logic 304 maintains a section status data structure 326 that is used to track the building of up to eight sections in parallel for use in building up to eight corresponding MPE-FEC frames. Status information maintained in data structure 326 for each section may include, but is not limited to, whether or not the section is valid, whether or not the section is an MPE section, whether or not the section is an FEC section, whether or not the section is a table, current partial cyclic redundancy check (CRC) results associated with the section, as well as information from and/or about the section header associated with the section.

It should be noted that sections are not actually built and stored within section manager 114. Rather, SM control logic 304 updates the status of sections currently being assembled within frame manager 116 by processing section data (and associated control/status signals) received from TS packet filter 112 “on the fly” prior to forwarding the section data to frame manager 116. In one embodiment, the section data need only reside in SM buffer 322 for one clock cycle prior to being forwarded to frame manager interface 306. This approach advantageously reduces the amount of time that section data must reside in section manager 114 and also reduces the amount of memory and control logic needed to implement section manager 114.

To increase performance, SM control logic 304 is also configured to perform a partial CRC of each section on the fly as section data is received from TS packet filter 112. Current partial CRC results for each section currently being built are stored in section status data structure 326. The performance of the partial CRC results in the generation of erasure bits corresponding to each byte of frame data that is passed on to frame manager 116. Erasure bits advantageously need not be stored within section manager 114.

SM control logic 304 also maintains a frame status data structure 324 that is used to facilitate the transmission of frame-related status and control information to frame manager 116. Frame status data structure 324 allows the status of eight frames to be maintained in parallel. Status information maintained for each frame may include, but is not limited to, whether or not the frame is valid, the PID associated with the frame, the value of a frame lookup pointer used to retrieve frame configuration data from frame configuration table 310, the number of good sections in the frame based on the CRC process, and whether or not the frame includes at least one bad section based on the CRC process.

SM control logic 304 is also configured to keep track of real-time parameters associated with a frame in frame status data structure 324, such as delta-T values and table/frame boundaries. The delta-T values are derived from MPE-FEC headers associated with sections and serve to provide an indication of when the next time slice associated with a given PID will be received. Delta-T values are defined with a 10 ms resolution and may be updated by the transmitter with each section. By tracking the delta-T values in this manner, section manager 114 advantageously allows power manager 108 to precisely identify time periods when no time slices are scheduled to be received by DVB-H receiver 100 and to power down RF tuner 102, DVB-H demodulator 104 and each of the sub-blocks within link layer logic 106 during such time periods. This results in a substantial power savings. The manner in which power manager 108 operates to perform this function will be described in more detail below.

SM control logic 304 is also configured to keep track of a table bit value in frame status data structure 324 that indicates when the end of the application data table has been received for a given MPE-FEC frame as well as a frame bit that indicates when the end of a particular MPE-FEC frame has been reached. These bits are derived from MPE-FEC headers associated with sections. Tracking of these bits advantageously allows section manager 114 to identify when application table data padding is needed and to decide whether or not FEC processing should be performed. Tracking of these bits also enable certain functionality of power manager 108 as will be described in more detail below.

To facilitate the management of each frame and the transmission of frame information to frame manager 116, SM control logic 304 is also configured to access frame configuration table 310. Frame configuration table 310 is a table that includes frame configuration information for each of 32 PIDs and that is accessed using a pointer provided by TS packet filter 112 (pf_lkup_ptr [4:0]). Frame configuration information for each PID may include, but is not limited to, whether the PID is valid, whether or not only MPE-FEC sections should be processed for the PID, whether FEC operations will be performed for all frames associated with this PID, whether the PID is associated with an MPE-FEC service or an MPE only service, and the number of rows in an MPE-FEC frame for the PID. The number of rows for a given PID may be 256 rows, 512 rows, 768 rows or 1024 rows, wherein 256 rows corresponds to the smallest MPE-FEC frame size and 1024 rows corresponds to the largest MPE-FEC frame size. The information stored in frame configuration table 310 may be set by a host via host interface 308.

SM control logic 304 is also configured to access global configuration register 312. Global configuration register 312 stores parameters related to the operation of SM control logic 304 that are not associated with a particular PID. These parameters may include, but are not limited to, an indication that frames should be received by the host without performing MPE-FEC when all sections in the frame are deemed good based on the CRC process, and a designation of a particular erasure marking scheme as discussed above.

When SM control logic 304 determines that section data corresponding to a new MPE-FEC frame has been received from TS packet filter 112, SM control logic 304 accesses frame configuration table 310 to determine the size of MPE-FEC frames for the PID associated with the new section. This access is made using the pf_lkup_ptr [4:0] provided by TS packet filter 112. Based on the frame size, SM control logic 304 then determines the number of frame buffers within frame manager 116 that would be needed to accommodate the new MPE-FEC frame. SM control logic 304 then compares the number of frame buffers needed to the number of frame buffers currently available, wherein the number of frame buffers currently available is provided as a signal from frame manager 116 via frame manager interface 306. If the number of frame buffers needed is greater than the number available, then SM control logic 304 will drop the new MPE-FEC frame. However, if the number of frame buffers needed is less than or equal to the number available, then SM control logic will initialize section- and frame-specific data structures for the new MPE-FEC frame and begin passing information pertaining to the new MPE-FEC frame to frame manager 116.

During the building of a given MPE-FEC frame, SM control logic 304 is responsible for providing frame data (which is derived from section data) and a logical address at which such frame data is to be stored to frame manager 116. SM control logic 304 is also responsible for providing erasure information associated with the frame data and, in some cases, a logical address at which such erasure information is to be stored within an erasure table to frame manager 116. As SM control logic 304 progresses in providing frame data and erasure information to frame manager 116, it updates relevant entries in section status data structure 326 and frame status data structure 324.

When SM control logic 304 determines that the end of an MPE-FEC frame has been reached, it notifies frame manager 116 and then clears all data structures currently being used to track the building of that MPE-FEC frame and sections associated therewith.

The communication of signals between section manager 114 and frame manager 116 is handled by frame manager interface 306. The signals transmitted to frame manager 116 in accordance with one implementation of the present invention are set forth in Table 4 below. Each of these signals will now be described.

TABLE 4
Signals Output from Section Manager to Frame Manager

| Signal Name | Pins | Active |
|---|---|---|
| sm_pid [12:0] | 13 | N/A |
| sm_data [31:0] | 32 | N/A |
| sm_data_valid [3:0] | 4 | N/A |
| sm_data_ersr [31:0] | 32 | N/A |
| sm_ersr_valid [31:0] | 32 | N/A |
| sm_addr [17:0] | 18 | N/A |
| sm_erasure | 1 | High |
| sm_sof | 1 | High |
| sm_row_num [2:0] | 3 | N/A |
| sm_fecen | 1 | High |
| sm_table | 1 | High |
| sm_adt_ladr [17:0] | 18 | N/A |
| sm_adt_ladr_update | 1 | High |
| sm_rs | 1 | High |
| sm_frame | 1 | High |
| sm_lkup_ptr [4:0] | 5 | N/A |
| sm_bus_valid | 1 | High |
| sm_fecskip | 1 | High |
| sm_frmdscrd | 1 | High |
| sm_incomplete | 1 | High |

The signal sm_pid [12:0] is used to carry the 13-bit PID associated with the MPE-FEC frame or erasure information being transmitted to frame manager 116.

The signal sm_data [31:0] is used to carry 4 bytes of MPE-FEC frame data associated with the PID indicated by sm_pid. The signals sm_data [31:24], [23:16], [15:8] and [7:0] are intended for logical addresses sm_addr, sm_addr+1, sm_addr+2 and sm_addr+3, respectively.

The signal sm_data_valid [3:0] is used to indicate whether each data byte in sm_data [31:0] is valid. The signals sm_data_valid [3], [2], [1] and [0] correspond to sm_data [31:24], [23:16], [15:8] and [7:0], respectively.

The signal sm_data_ersr [31:0] is used to carry erasure bits associated the PID indicated by sm_pid. When sm_erasure is “0”, sm_data_ersr [3], [2], [1] and [0] carry erasure bits that correspond to sm_data [31:24], [23:16], [15:8] and [7:0], respectively. However, when sm_erasure is “1”, all 32 bits of sm_data_ersr [31:0] may be used to carry erasure bits.

The signal sm_ersr_valid [31:0] is used to indicate the valid status of each erasure bit. When sm_erasure is “0”, sm_ersr valid [3], [2], [1] and [0] correspond to sm_data_ersr [3], [2], [1], and [0], respectively. When sm_erasure is “1”, sm_ersr_valid [31:0] corresponds to sm_data_ersr [31:0], respectively.

The signal sm_addr [17:0] is used to carry a logical address within an MPE-FEC frame or erasure table at which to store data conveyed from section manager 114 to frame manager 116.

The signal sm_erasure is used to indicate which of two modes for conveying erasure information to frame manager 116 is being used, as discussed above with respect to signal sm_data_ersr [31:0]. When sm_erasure is “0”, sm_data [31:0], sm_data_valid [3:0], sm_data_ersr [31:0], sm_ersr valid [31:0] and sm_addr [17:0] are valid. When sm_erasure is “1”, sm_data [31:0] and sm_data_valid [3:0] should be ignored and sm_data_ersr [31:0], sm_ersr valid [31:0] and sm_addr [17:0] are valid.

The signal sm_sof is asserted to indicate the start of the MPE-FEC frame or erasure bits associated with the PID indicated by sm_pid. The sm_sof signal is also used to validate the sm_lkup_ptr [4:0], sm_row_num [2:0] and sm_fecen signals.

The signal sm_row_num [2:0] indicates the total number of rows in the MPE-FEC frame that is associated with the PID indicated by sm_pid. In one implementation, a value of “000” denotes 256 rows, a value of “001” denotes 512 rows, a value of “010” denotes 768 rows, and a value of “011” denotes 1024 rows.

The signal sm_fecen is asserted to indicate that FEC is used in the MPE-FEC frame that is associated with the PID indicated by sm_pid. If this signal is not asserted, FEC is not used.

The signal sm_table is asserted to indicate the completion of a table within the MPE-FEC frame for which data is currently being transmitted to frame manager 116. When sm_table is “1” and sm_frame is “0”, the completion of the application data table is indicated. When sm_table is “1” and sm_frame is “1”, the completion of the Reed Solomon (RS) data table indicated.

The signal sm_adt_ladr [17:0] is used to convey the last data address in the application data table within the MPE-FEC frame currently being transmitted to frame manager 116.

The signal sm_adt_ladr_update is used to indicate a valid last data address in the Application Data Table. When sm_adt_ladr_update is “1”, sm_adt_ladr [17:0] is valid. Otherwise, sm_adt_ladr [17:0] should be ignored. The signal sm_adt_ladr_update should be asserted at least once for each MPE-FEC or MPE-only frame. The signal sm_adt_ladr_update is also used by frame manager 116 to gate sm_bus_valid—that is, when sm_adt_ladr_update is “1”, sm_bus_valid is treated as “0” by frame manager 116 regardless of the value set by section manager 114.

The signal sm_rs is asserted to indicate that MPE-FEC frame data carried by sm_data [31:0] is RS data.

The signal sm_frame is asserted to indicate the end of the MPE-FEC frame associated with the PID indicated by sm_pid. When sm_frame is “1”, sm_fec_skip, sm_frmdscrd and sm_incomplete are valid. Otherwise, sm_fec_skip, sm_frmdscrd and sm_incomplete should be ignored.

The signal sm_lkup_ptr [4:0] is a pointer that indicates the position of the PID indicated by sm_pid within frame configuration table 310. This pointer is passed via frame manager 116 to IP filter 118 and is used by IP filter 118 to access a similarly-organized table that is logically associated with TS packet filter table 212 and frame configuration table 310.

The signal sm_bus_valid is asserted to indicate the valid status of frame data and/or frame status signals transmitted from section manager 114 to frame manager 116. In particular, when sm_bus_valid is “1”, sm_pid, sm_data[31:0], sm_data_valid [3:0], sm_data_ersr [31:0], sm_ersr_valid [31:0], sm_addr [17:0], sm_erasure, sm_sof sm_table, sm_rs and sm_frame are valid. Otherwise, these signals should be ignored.

The signal sm_fecskip is asserted to indicate to frame manager 116 that the MPE-FEC frame associated with the PID indicated by sm_pid does not need to undergo error correction and can instead be sent directly to IP filter 118.

The signal sm_frmdscrd is asserted to indicate to frame manager 116 that the MPE-FEC frame associated with the PID indicated by sm_pid should be discarded.

The signal sm_incomplete is asserted to indicate that the MPE-FEC frame associated with the PID indicated by sm_pid has a missing section.

The signals received from frame manager 116 via frame manager interface 306 in accordance with one implementation of the present invention are set forth in Table 5 below. Each of these signals will now be described.

TABLE 5
Signals Input to Section Manager from Frame Manager

| Signal Name | Pins | Active |
|---|---|---|
| fm_empty_buf [3:0] | 4 | N/A |
| fm_accept_sof | 1 | High |
| fm_accept_sof_val | 1 | High |
| fm_hold | 1 | High |

The signal fm_empty_buf indicates the number of empty frame buffers within frame manager 116. When fm_empty_buf [3:0] is “0000”, no frame buffers are available. When fin_empty_buf [3:0] is any value from “0001” through “1000”, the number of available frame buffers is binary encoded. The values “1001” through “1111” are reserved.

The signal fm_accept_sof, when asserted, indicates that frame manager 116 has accepted the sm_sof signal from section manager 114 and that a new frame has been started by frame manager 116.

The signal fm_accept_sof_val is used to indicate the valid status of the fm_accept_sof signal. When fm_accept_sof_val is “1”, fm_accept_sof is valid. Otherwise, fm_accept_sof should be ignored.

The signal fm_hold is used to indicate to section manager 114 that frame manager 116 is not ready for new receptions. When fm_hold is “1”, section manager 114 should not send any new data or status signals to frame manager 116 and, if sent, they will be ignored by frame manager 116.

5. Frame Manager

Frame manager 116 is another sub-block within link layer logic 106. Among other functions, frame manager 116 is configured to receive frame data and associated status and control information from section manager 114 and to use this data to build MPE-FEC frames in frame buffers located within frame manager 116. Frame manager 116 is configured to build up to eight separate MPE-FEC frames in parallel, depending on the frame sizes. Frame manager 116 is also configured to receive and store erasure information associated with each MPE-FEC frame. Frame manager 116 is further configured to perform MPE-FEC error-correcting operations on each buffered MPE-FEC frame (using the associated erasure information) and to make each error-corrected frame available for reading to IP filter 118.

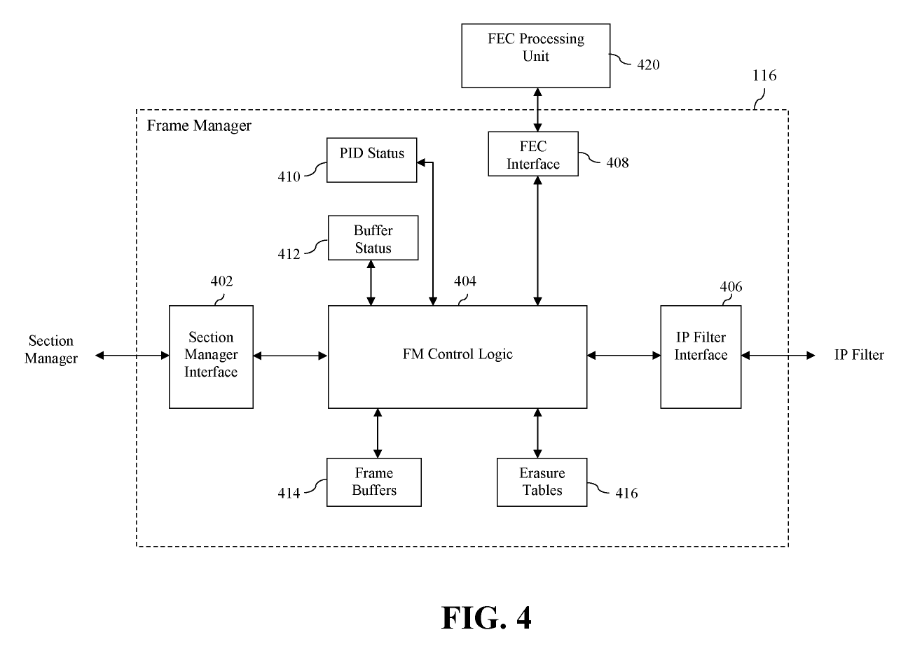

FIG. 4 is a block diagram that shows frame manager 116 in more detail. As shown in FIG. 4, frame manager 116 includes a number of interconnected logic blocks including a section manager interface 402, FM control logic 404, an IP filter interface 406, an FEC interface 408, a PID status table 410, a buffer status table 412, frame buffers 414, and erasure tables 416. Each of these logic blocks will be described in more detail below.

Section manager interface 402 is configured to handle the transmission of signals to section manager 114 and the receipt of signals from section manager 114. Signals transmitted to section manager 114 are described above in reference to Table 5. Signals received from section manager 114 are described above in reference to Table 4.

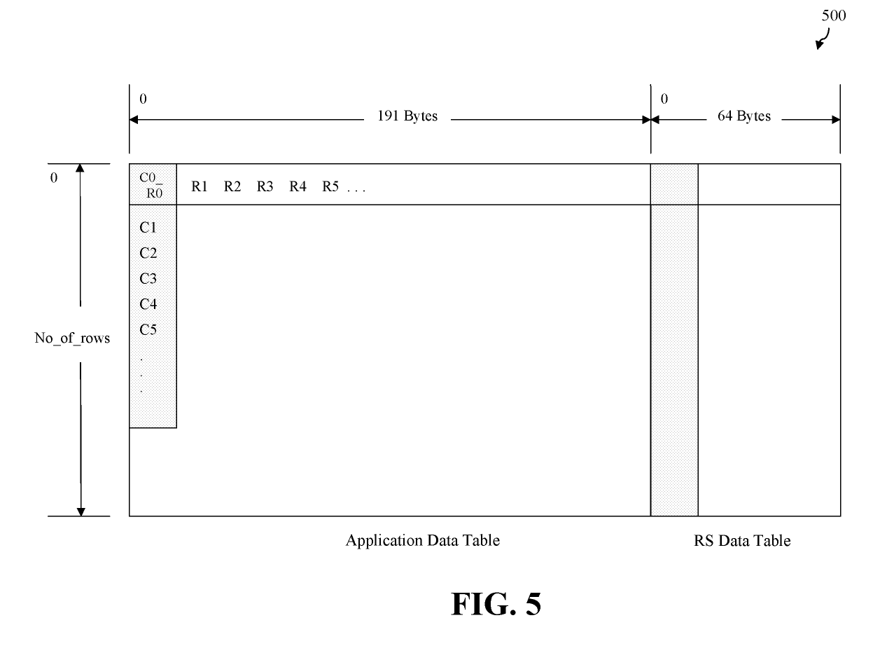

Frame manager 116 includes eight frame buffers 414, each frame buffer being capable of storing one minimal sized MPE-FEC frame. A logical representation 500 of an MPE-FEC frame is depicted in FIG. 5. Each MPE-FEC frame consists of 255 columns and 256, 512, 768 or 1024 rows. Thus, the minimal sized MPE-FEC frame has 256 rows while the largest sized MPE-FEC frame has 1024 rows. Each cell within the frame corresponds to a single byte and the maximum frame size is approximately 2 Mbits. As shown in FIG. 5, the frame is separated into two adjacent tables: an application data table and an RS data table.

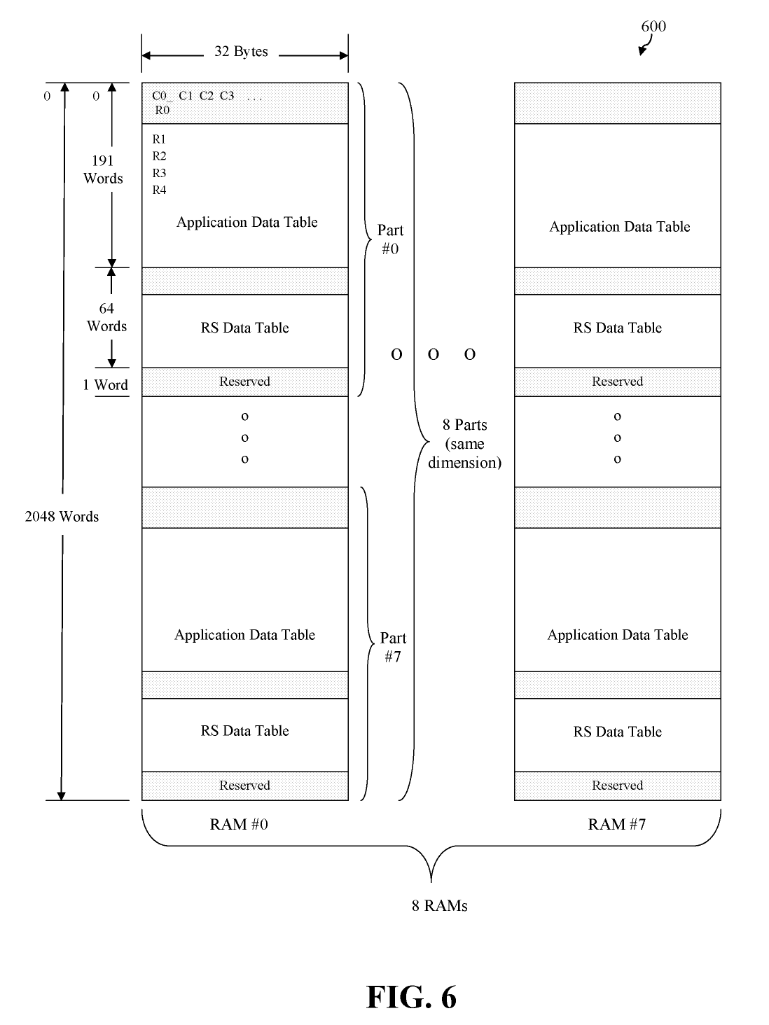

The physical implementation of the eight frame buffers 414 is shown in block diagram 600 of FIG. 6. This implementation includes a total of eight random access memories (RAMs), denoted RAM #0 through RAM #7, each of which is subdivided into 8 parts, denoted part #0 through part #7. Each RAM is capable of storing one minimal sized MPE-FEC frame. All eight RAMs are of the same size, which is 524,288 bits (8 parts×256 words×32 bytes×8 bits).

Frame manager 116 also includes erasure tables 416 that correspond to the MPE-FEC frames stored in frame buffers 414. Erasure tables 416 are implemented using 8 RAMs. All of the RAMs are of the same size, which is 65,536 bits (8 parts×256 words×32 bits).

FM control logic 404 is configured to perform a variety of functions relating to the building of MPE-FEC frames and the performance of MPE-FEC decoding of those frames. Among other functions, FM control logic 404 manages the eight frame buffers 414 and dynamically allocates such buffers for concurrently building anywhere from one to eight MPE-FEC frames, depending on the size of such frames. To assist in managing frame buffers 414, FM control logic maintains a buffer status table 412 that indicates the usage of each frame buffer. FM control logic 404 further provides section manager 114 with information about the availability of frame buffers from buffer status table 412 so that section manager 114 can determine whether there is enough space to start a new MPE-FEC frame for an incoming elementary stream.

When a new MPE-FEC frame is started (denoted by the assertion of the sm_sof signal by section manager 114), FM control logic 404 obtains the PID, number of rows, and other information associated with the MPE-FEC frame from section manager interface 402 and uses such information to set up a new PID entry for the PID in PID status table 410. Based on the size of the MPE-FEC frame (sm_row_num [2:0]), and the number of available empty frame buffers according to buffer status table 412, FM control logic 404 selects one or more frame buffers to store the MPE-FEC frame. This information is written to the entry created for the PID in PID status table 410. PID status table 410 contains a maximum of eight entries. FM control logic 404 updates buffer status table 412 whenever a PID entry is added to or deleted from PID status table 410.

When frame data is received from section manager 114, FM control logic 404 accesses the PID status table to determine which frame buffer(s) should be used to store the associated MPE-FEC frame data. FM control logic 404 also translates logical addresses provided by section manager 114 to physical addresses at which to store the frame data within frame buffers 414. In one implementation, the same address translation scheme is used for storing erasure information received from section manager 114 as is used for storing frame data, such that each byte in a frame buffer and its corresponding erasure bit in an erasure table have the same physical address.

FM control logic 404 monitors the status of each MPE-FEC frame for which a PID entry has been created in PID status table 410 to determine when the MPE-FEC frame is ready for FEC processing. If an MPE-FEC frame is ready for FEC processing, then FM control logic 404 notifies FEC interface 408. Responsive to the notification, FEC interface 408 sends each row of the MPE-FEC frame to FEC processing unit 420 for error correction. After error correction, FEC interface 408 writes the data bytes back to their original location. When all the rows of an MPE-FEC frame have been corrected, FM control logic 404 updates the PID entry corresponding to the MPE-FEC frame. It should be noted that if sm_fec_skip was asserted for the MPE-FEC frame, then the frame will be sent directly to IP filter 118 without first being processed by FEC processing unit 420.

FM control logic 404 also monitors the status of each MPE-FEC frame for which a PID entry has been created in PID status table 410 to determine when the MPE-FEC frame is ready to be drained by IP filter 118. If an MPE-FEC frame is ready to be drained by IP filter 118, FM control logic 404 notifies IP filter 118 via IP filter interface 406 and also sends related PID information. FM control logic 404 then uses addresses supplied by IP filter 118 via IP filter interface 406 to read the MPE-FEC frame from the appropriate frame buffer(s) and associated erasure information from the appropriate erasure table and sends the frame data and erasure information to IP filter 118. FM control logic 404 uses an address translation scheme as discussed above to translate logical addresses provided by IP filter 118 to physical addresses within the appropriate frame buffer(s) and erasure table.

FM control logic 404 determines when an MPE-FEC frame has been drained by IP filter 118 by monitoring a frame done signal received from IP filter 118 via IP filter interface 406. Responsive to determining that an MPE-FEC frame has been drained by IP filter 118, FM control logic 404 deletes the PID entry associated with the MPE-FEC frame and recycles the frame buffers used by that MPE-FEC frame as well as the associated erasure table for the frame. Recycling of the frame buffers and erasure table involves initialization of the RAMs used to implement the erasure table.

IP filter interface 406 is configured to transmit and receive signals to and from IP filter 118. The signals transmitted to IP filter 118 in accordance with one implementation of the present invention are set forth in Table 6 below. Each of these signals will now be described.

TABLE 6
Signals Output from Frame Manager to IP Filter

| Signal Name | Pins | Active |
|---|---|---|
| fm_pid [12:0] | 13 | N/A |
| fm_lkup_ptr [4:0] | 5 | N/A |
| fm_row_num [2:0] | 3 | N/A |
| fm_adt_ladr [17:0] | 18 | N/A |
| fm_unccrctdrm | 1 | High |
| fm_sof | 1 | High |
| fm_all_drained | 1 | High |
| fm_pnd_frm [3:0] | 4 | N/A |
| fm_data [31:0] | 32 | N/A |
| fm_byte_ersr [3:0] | 4 | N/A |
| fm_data_valid | 1 | High |

The signal fm_pid [12:0] is used to carry the 13-bit PID associated with the MPE-FEC frame or erasure information being drained by IP filter 118.

The signal fm_lkup_ptr [4:0] is a pointer that indicates the position of the PID indicated by fm_pid within a lookup table. This pointer is passed from frame manager 116 to IP filter 118 and is used by IP filter 118 to access a table that is logically associated with TS packet filter table 212 and frame configuration table 310.

The signal fm_row_num [2:0] indicates the total number of rows in the MPE-FEC frame that is associated with the PID indicated by sm_pid. In one implementation, a value of “000” denotes 256 rows, a value of “001” denotes 512 rows, a value of “010” denotes 768 rows, and a value of “011” denotes 1024 rows.

The signal fm_adt_ladr [17:0] is used to convey the last data address in the application data table within the MPE-FEC frame currently being drained by IP filter 118.

The signal fm_uncrrctdfrm is asserted to indicate that the MPE-FEC frame identified by fm_pid [12:0] is uncorrectable by FEC processing unit 420.

The signal fm_sof is asserted to indicate that a completed MPE-FEC frame is ready for IP filter 118. The fm_sof signal is also used to validate the fm_pid, fm_lkup_ptr [4:0], fm_row_num [2:0], fm_adt_ladr [17:0], and fm_uncrrctedfrm signals.

The signal fm_all_drained is asserted when there are no valid frames in frame buffer 414.

The signal fm_pnd_frm [3:0] is used to indicate the number of pending frames in frame buffer 414, including the one currently in the process of being drained by IP filter 118.

The signal fm_data [31:0] is used to carry 4 bytes of MPE-FEC frame data associated with the PID indicated by fm_pid. The signals fm_data [31:24], [23:16], [15:8] and [7:0] are from addresses sm_addr, sm_addr+1, sm_addr+2 and sm_addr+3, respectively.

The signal fm_data_ersr [31:0] is used to indicate the erasure status of the frame data being drained by IP filter 118. The signals fm_data_ersr [3], [2], [1] and [0] carry erasure bits that correspond to fm_data [31:24], [23:16], [15:8] and [7:0], respectively. When a bit in fm_byte_ersr is “1”, this indicates that the corresponding data byte has been marked as erasure.

The signal fm_data_valid [3:0] is used to indicate the valid status of the frame data and erasure information. When fm_data valid is “1”, fm_data [31:0] and f_data_ersr [31:0] are valid. Otherwise, fm_data [31:0] and fm_data_ersr [31:0] should be ignored.

The signals received from IP filter 118 via IP filter interface 406 in accordance with one implementation of the present invention are set forth in Table 7 below. Each of these signals will now be described.

TABLE 7
Signals Input to Frame Manager from IP Filter

| Signal Name | Pins | Active |
|---|---|---|
| ipf_addr [17:0] | 18 | N/A |
| ipf_addr_valid | 1 | High |
| ipf_frm_done | 1 | High |

The signal ipf_addr [17:0] indicates the logical address in the MPE-FEC frame from which to read outgoing data.

The signal ipf_addr_valid indicates the valid status of the read address ipf_addr [17:0]. When ipf_addr valid is “1”, ipf_addr [17:0] is valid. Otherwise, ipf_addr [17:0] should be ignored.

The signal ipf_frm_done indicates the end of the MPE-FEC frame currently being drained by IP filter 410. When ipf_frm_done is “1”, the MPE-FEC frame has been processed by IP filter 118 and thus may be discarded.

6. IP Filter

Among other features, IP filter 118 is configured to read data from the MPE-FEC frames built by frame manager 116 and to generate IP packets therefrom. MPE-FEC frames are read by IP filter 118 in a serial fashion. To perform this function, IP filter 118 is configured to provide logical addresses to frame manager 116 for reading data from MPE-FEC frames and to align data read from the MPE-FEC frames. Such data is drained in 4-byte segments. IP filter 118 also indicates to frame manager 116 when it has finished reading an MPE-FEC frame.

IP filter 118 is also configured to filter out selected IP packets from the generated IP packets for transfer to a host. The selected IP packets may be used by an application program executing on a system or device that is communicatively connected to DVB-H receiver 100 or that is executing on a system or device of which DVB-H receiver 100 is a part.

B. Power Management for DVB-H Receiver

As mentioned above, power manager 108 operates to reduce the average power consumption of DVB-H receiver 100 by powering down RF tuner 102, DVB-H demodulator 104 and each of the sub-blocks within link layer logic 106 during time periods when no bursts associated with requested services are scheduled to be received by DVB-H receiver 100. The structure of power manager 108 and the manner in which it performs these functions will now be described.

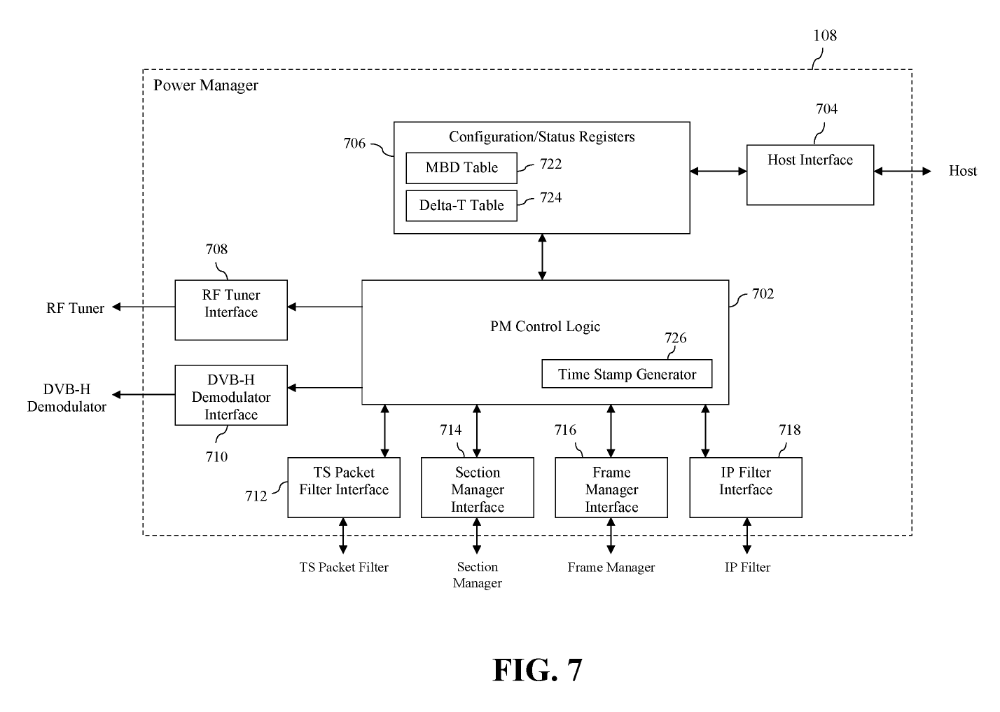

FIG. 7 is a block diagram that shows power manager 108 in more detail. As shown in FIG. 7, power manager 108 includes a number of interconnected logic blocks including power manager (PM) control logic 702, a host interface 704, configuration/status registers 706, an RF tuner interface 708, a DVB-H demodulator interface 710, a TS packet filter interface 712, a section manager interface 714, a frame manager interface 716 and an IP filter interface 718. Each of these logic blocks will be described in more detail below.

PM control logic 702 comprises logic that is configured to determine when each of RF tuner 102, DVB-H demodulator 104 and each of the sub-blocks within link layer logic 106 (TS packet filter 112, section manager 114, frame manager 116 and IP filter 118) is eligible for power down and to cause those components to be powered down when appropriate. PM control logic 702 is further configured to determine when such components should be returned to a powered up state and to cause those components to return to a powered up state when appropriate. As will be described in more detail below, PM control logic 702 performs these functions, in part, by maintaining and periodically checking entries within a maximum burst duration (MBD) table 722 and a delta-T table 724. These tables are stored within a set of configuration/status registers 706, as shown in FIG. 7.

Host interface 704 comprises an interface by which a host processor can read and write certain registers within configuration/status registers 706. As will be discussed in more detail herein, this advantageously allows a host processor to programmatically control certain aspects of the operation of PM control logic 702. Furthermore, in certain implementations, a host processor may be used to power down and/or power up components of DVB-H receiver 100 responsive to interrupt signals generated by power manager 108. These interrupts may be generated responsive to the setting of certain status registers within configuration/status registers 706 by PM control logic 702.

RF tuner interface 708 and DVB-H demodulator interface 710 comprise interfaces by which PM control logic 702 can send control signals to indicate that RF tuner 102 and DVB-H demodulator 104 can be powered down, respectively. TS packet filter interface 712, section manager interface 714, frame manager interface 716 and IP filter interface 718 comprise interfaces by which PM control logic 702 can power down TS packet filter 112, section manager 114, frame manager 116 and IP filter 118, respectively, through the gating of clock signals to those logic blocks. Section manager interface 714 also comprises input/output ports by which PM control logic 702 can communicate with section manager 114 for the purpose of tracking MBD timers and delta-T values for a certain number of requested services. As will be discussed in more detail below, the tracking of these MBD timers and delta-T values facilitates the making of power down and power up determinations by PM control logic 702.

The manner in which the aforementioned components of power manager 108 operate to perform power management functions will now be described. First, the operation of power manager 108 during system startup will be described. Second, the operation of power manager 108 in conjunction with section manager 114 to maintain MBD timers and delta-T information for a certain number of requested services will be described. Third, the manner by which power manager 108 determines that components of DVB-H receiver 100 are eligible for power down and by which power manager 108 causes those elements to be powered down will be described. Finally, the manner by which power manager 108 determines that components of DVB-H receiver 100 should be powered up and by which power manager 108 causes those elements to be powered up will be described.

1. Power Management System Startup

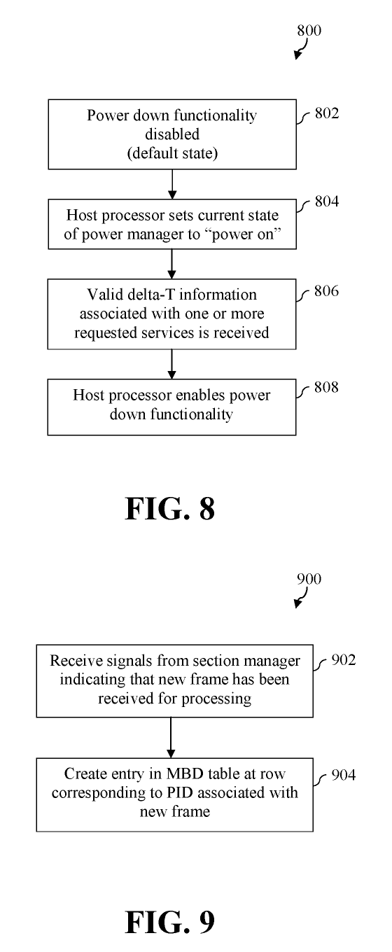

FIG. 8 depicts a flowchart 800 of a series of steps that occur with respect to power manager 108 during system startup. As shown at step 802, the functionality within power manager 108 that causes components of DVB-H receiver 100 to be powered down is initially disabled by default. At startup, a host processor sets a current state of power manager 108 to “power on” as shown at step 804. In this state, power manager 108 will operate to ensure that RF tuner 102, DVB-H demodulator 104 and all of the sub-blocks of link layer logic 106 are each fully powered. Steps 802 and 804 are necessary to ensure that DVB-H receiver 100 is able to perform essential functions after system startup such as receiving DVB-H broadcasts and extracting Program Specific Information/System Information (PSI/SI) associated with requested services therefrom.

The foregoing steps are also necessary to ensure that valid delta-T information associated with one or more requested services is captured by DVB-H receiver 100, which occurs at step 806. This delta-T information indicates when a subsequent time slice may be expected for a particular service and, as will be described in more detail below, is derived from sections processed by section manager 114 that pass CRC testing. Without such delta-T information, power manager 108 cannot operate properly to determine when components of DVB-H receiver may be powered down.

At step 808, after having received valid delta-T information associated with one or more requested services as shown at step 806, the host processor enables the functionality within power manager 108 that causes components of DVB-H receiver 100 to be powered down. This functionality will be described in more detail below. It is to be understood that the host processor sets the state of power manager 108 in step 804 and enables the power down functionality in step 808 by writing to certain registers within configuration/status registers 706.

2. Maintenance of MBD Timers and Delta-T Information

As noted above, power manager 108 operates in conjunction with section manager 114 to maintain MBD timers and delta-T information for a certain number of requested services. The maintenance of this information enables PM control logic 702 within power manager 108 to determine when components of DVB-H receiver 100 are eligible for power down as well as when such components of DVB-H receiver 100 should be powered up.

a. Maintenance of MBD Timers

The maintenance of MBD timers will now be described. PM control logic 702 sets an MBD timer each time section manager 114 begins to receive a new frame associated with a requested service. This is depicted in flowchart 900 of FIG. 9. As shown at step 902 of that flowchart, when section manager 114 receives a new frame for processing, it signals this event to PM control logic 702. Section manager 114 may signal this event at approximately the same time that it asserts the start of frame signal (sm_sof) to frame manager 116. Responsive to the signaling, PM control logic 702 sets an MBD timer for the new frame by creating an entry in MBD table 722 at a row corresponding to the PID associated with the new frame. This is shown at step 904. In one embodiment, PM control logic 702 can set an MBD timer for frames corresponding to 32 different requested services (or PIDs).

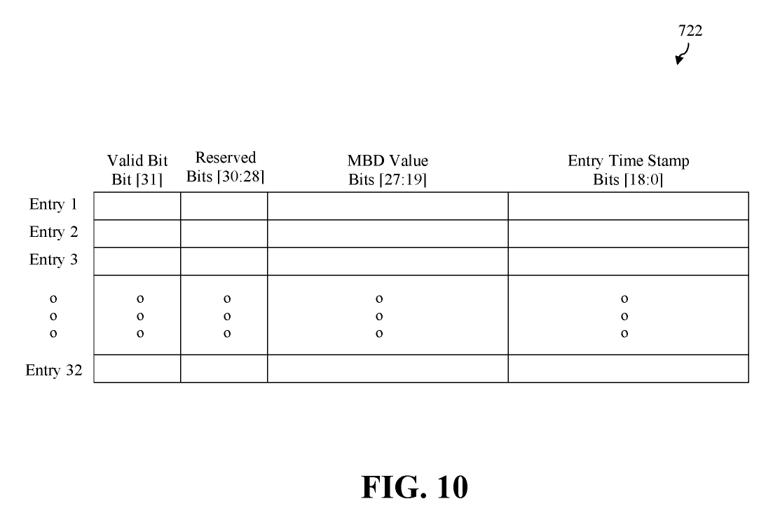

FIG. 10 depicts an example implementation of MBD table 722. As shown in FIG. 10, MBD table 722 includes 32 rows, wherein each row corresponds to one of 32 different requested services. A 5-bit pointer associated with each requested service is used for accessing the table. Each entry in MBD table 722 comprises 32 bits, wherein bit [31] represents a valid bit, bits [30:28] are reserved, bits [27:19] represent an MBD value associated with a frame corresponding to the requested service, and bits [18:0] represent an entry time stamp indicating the time at which the MBD value was entered.

When PM control logic 702 creates an entry for a frame, it populates the MBD field and entry time stamp and then sets the valid bit to indicate that the information is valid. The MBD field is populated with an MBD value associated with the PID. The MBD value for a PID specifies the maximum amount of time over which a burst may be transmitted for the service identified by the PID. The MBD value is obtained as part of PSI/SI information previously received by DVB-H receiver 100 and is made available to PM control logic 702 by a host processor.

The entry time stamp is obtained from a time stamp generator 726 located within PM control logic 702 and indicates the current time at which the MBD field was populated. In one embodiment, time stamp generator 726 comprises a 19-bit counter that is incremented every 100 microseconds (μs).

When any of the entries within MBD table 722 are designated valid, then it is may be assumed that a frame is currently being processed by link layer logic 106 within DVB-H receiver 100. Thus, as will be discussed in more detail below, power manager 108 will not power down any components of DVB-H receiver 100 while this condition holds true.

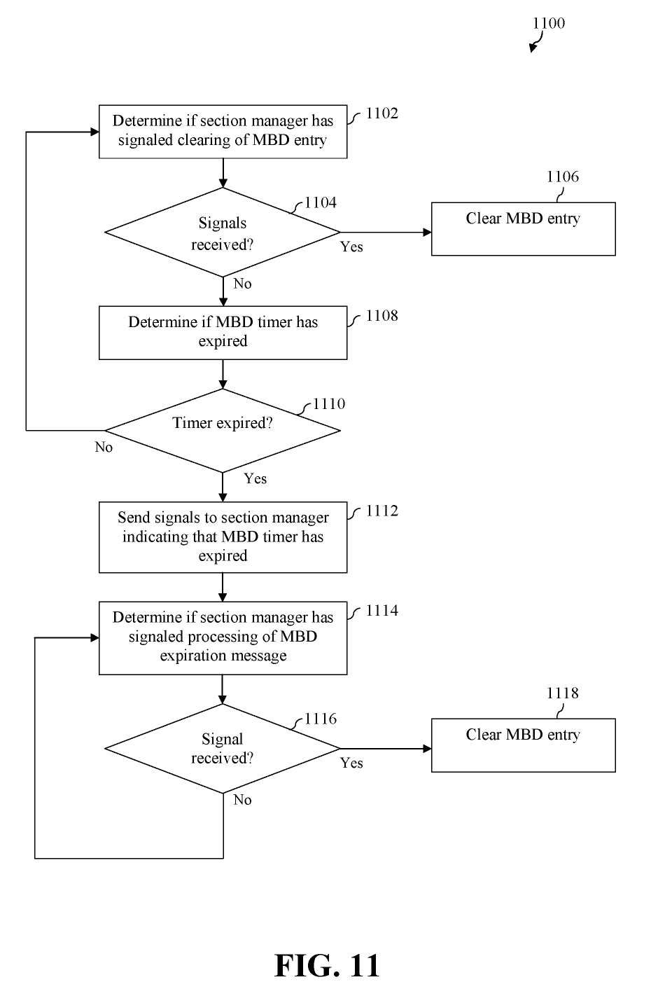

PM control logic 702 is configured to clear an entry within MBD table 722 responsive to only two conditions—the first condition is the receipt of an appropriate set of signals from section manager 114 and the second condition is the expiration of the MBD timer associated with the entry in MBD table 722. A method by which PM control logic 702 clears a particular entry within MBD table 722 will now be described in reference to flowchart 1100 of FIG. 11. The method of flowchart 1100 is performed periodically by PM control logic 702 for each valid entry in MBD table 722.

As shown in FIG. 11, the method of flowchart 1100 begins at step 1102, in which PM control logic 702 determines whether section manager 114 has signaled the clearing of an MBD entry. Section manager 114 is configured to signal the clearing of an MBD entry responsive to either (1) determining that the application data table portion of an MPE FEC frame associated with the entry has been received in the case where no MPE FEC error correction of the frame is required or (2) that the end of the entire MPE FEC frame associated with the MBD table entry has been received in the case where MPE FEC error correction of the frame is required.

The determination by section manager 114 of whether MPE FEC error correction is required for a particular frame may be based on whether all of the sections that make up the frame have passed CRC testing. The determination may also be based on the integrity of logical address information associated with each section included in the frame. Still further, the determination may be based on signals from TS packet filter 112 indicating that a transport stream packet that was used to build the frame was received from DVB-H demodulator 104 with errors (pf_erasure) or that a transport stream packet that was used to build the frame was received out of sequence (pf_squ_ind). As described elsewhere herein, TS packet filter 112 may generate the pf_erasure signal based on the ts_err [1:0] signal received from DVB-H demodulator 104, based on header information included in the relevant transport stream packet, or based on both.

Section manager 114 can signal the clearing of an MBD entry upon receipt of the application data table portion of an MPE FEC frame in a situation where no MPE FEC error correction is required because the remaining portion of the MPE FEC frame (i.e., the RS data table) is not required to complete processing of the frame. Thus, DVB-H receiver 100 need not remained powered on to receive this remaining portion. The ability of section manager 114 to signal the clearing of an MBD entry upon receipt of only the application data table portion of a frame advantageously allows PM control logic 702 to more rapidly ascertain that the appropriate conditions for power down exist in certain situations.

Returning now to flowchart 1100, if PM control logic 702 determines at decision step 1104 that section manager 114 has signaled the clearing of an MBD entry, PM control logic 702 clears the MBD entry in MBD table 722 as shown at step 1106. Clearing an MBD entry may comprise setting a valid bit associated with the MBD entry to a value indicating that the MBD entry is invalid. Clearing an MBD entry may also comprise setting an MBD value and/or a time entry stamp associated with the MBD entry to zero.

However, if PM control logic 702 determines at decision step 1104 that section manager 114 has not signaled the clearing of the MBD entry, then processing proceeds to step 1108, in which PM control logic 702 determines if an MBD timer associated with the MBD entry has expired, which may also be referred to as an MBD timeout.

An MBD timer associated with the MBD entry has expired if the amount of time elapsed since the setting of the entry time stamp associated with the MBD entry exceeds the MBD value associated with the MBD entry. In other words, an MBD timer associated with the MBD entry has expired if:

current time−time indicated by entry time stamp>MBD value.

In one embodiment, PM control logic 702 determines the current time by obtaining a time stamp from time stamp generator 726 and calculates elapsed time by subtracting the obtained time stamp from the entry time stamp. The elapsed time is then compared to the MBD value. In some implementations, either the elapsed time or the MBD value may be modified to account for a difference in resolution between the time units in which the elapsed time and the MBD value are measured.

If PM control logic 702 determines at decision step 1110 that the MBD timer has not expired, then PM control logic 702 continues to monitor conditions necessary to clear the MBD table entry as generally indicated by the arrow returning from decision step 1110 to step 11102.

However, if PM control logic 702 determines at decision step 1110 that the MBD timer has expired, then PM control logic 702 sends a signal to section manager 114 indicating that the MBD timer has expired as shown at step 1112. Responsive to receiving this signal, section manager 114 will conclude processing of the frame associated with the MBD table entry regardless of the fact that an end of frame condition has not been detected. This process ensures that section manager 114 will conclude frame processing even in situations where an end of frame or end of table flag (normally included as part of a section header) has not been received due to a transmission error. The likelihood that such an error has occurred is indicated by the fact that MBD associated with the requested service has been exceeded. By concluding frame processing when such conditions exist, this feature advantageously reduces the average power consumed by DVB-H receiver 100.

After sending the signal indicating that the MBD timer has expired to section manager 114 at step 1112, PM control logic 702 will wait to receive a confirmation signal back from section manager 114 indicating that the MBD timer expiration signal has been processed by section manager 1114. This is indicated by step 1114 and decision step 1116. If PM control logic 702 determines at decision step 1116 that the confirmation signal has not yet been received, then PM control logic 702 continues to monitor for receipt of that signal as generally indicated by the arrow returning from decision step 1116 to step 1114.

However, if PM control logic 702 determines at decision step 1116 that the confirmation signal has been received, then PM control logic 702 clears the MBD entry in MBD table 722 as shown at step 1118. The manner in which an MBD entry may be cleared was discussed above in reference to step 1106.

b. Maintenance of Delta-T Information

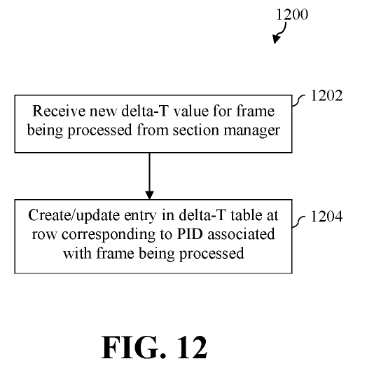

The maintenance of delta-T information will now be described. Generally speaking, PM control logic 702 records a new delta-T value for a frame each time section manager 114 determines that a section associated with that frame has been deemed good based on a CRC process. This is depicted in flowchart 1200 of FIG. 12. As shown at step 1202 of that flowchart, when section manager 114 receives a section that has been deemed good based on a CRC process, it provides a delta-T value included in the header of that section to PM control logic 702. Responsive to the receiving the new delta-T value, PM control logic 702 creates or modifies an entry in delta-T table 722 at a row corresponding to the PID associated with the relevant frame, so that the entry reflects the new delta-T information. This is shown at step 1204. In one embodiment, PM control logic 702 can maintain delta-T values for frames corresponding to 32 different requested services (or PIDs).

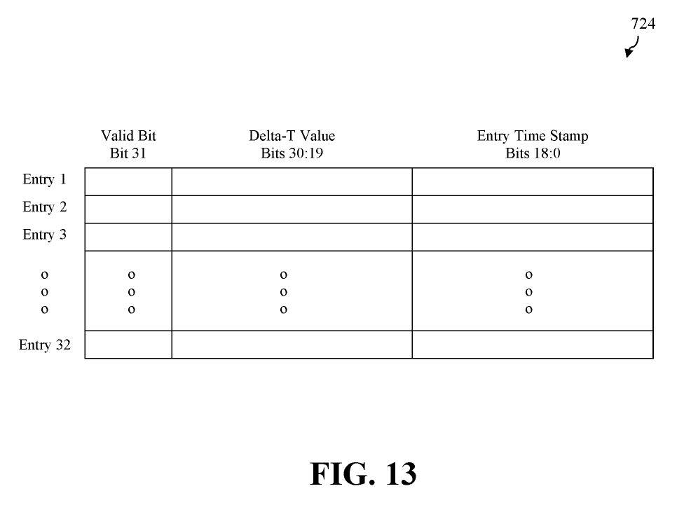

FIG. 13 depicts an example implementation of delta-T table 724. As shown in FIG. 13, delta-T table 724 includes 32 rows, wherein each row corresponds to one of 32 different requested services. A 5-bit pointer associated with each requested service is used for accessing the table. Each entry in delta-T table 724 comprises 32 bits, wherein bit [31] represents a valid bit, bits [30:19] represent a delta-T value associated with a frame corresponding to the requested service, and bits [18:0] represent an entry time stamp indicating the time at which the delta-T value was entered.

When PM control logic 702 creates/modifies an entry for a frame, it populates the delta-T field and entry time stamp and then sets the valid bit to indicate that the information is valid. The delta-T field is populated with a delta-T value associated with the PID, which is received from section manager 114 in a manner described above. The entry time stamp is obtained from time stamp generator 726 located within PM control logic 702 and indicates the current time at which the delta-T field was populated. As noted above, in one embodiment, time stamp generator 726 comprises a 19-bit counter that is incremented every 100 μs.

Delta-T values may be updated by a DVB-H transmitter with each new section to provide a more current estimate of the time at which a next time slice associated with a given PID will be received. By capturing and updating the delta-T values stored in table 724 based on the most-recently received section in a frame, an embodiment of the present invention is able to more accurately track when time slices are to be received and therefore more accurately determine when the components of DVB-H receiver 100 may be powered down. This advantageously helps to reduce the average power consumed by DVB-H receiver 100.

3. Power-down Determination and Execution

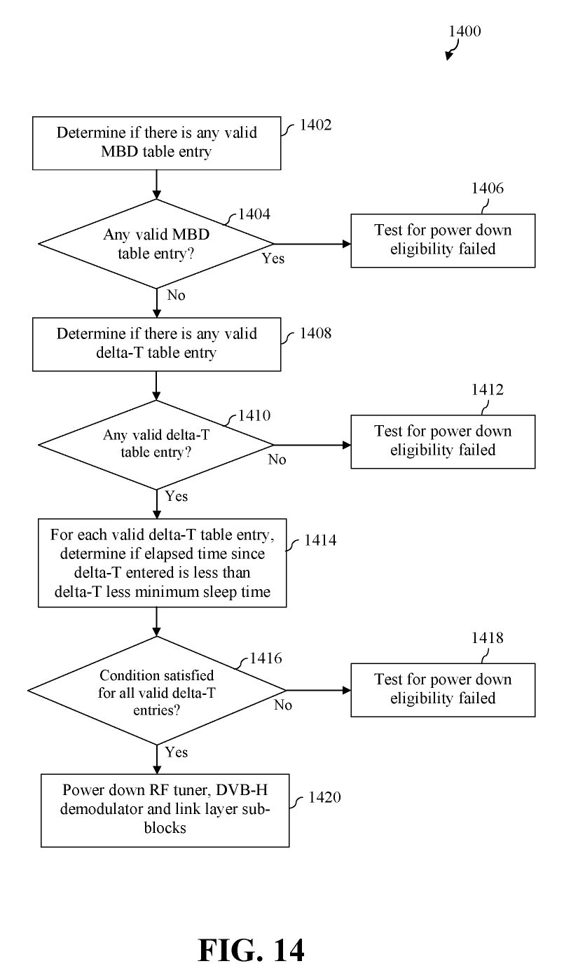

The manner in which PM control logic 702 determines if certain components of DVB-H receiver 100 are eligible for power down will now be described in reference to flowchart 1400 of FIG. 14. PM control logic 702 performs the test for power down eligibility represented by flowchart 1400 on a periodic basis. In one implementation, PM control logic 702 performs the test for power down eligibility once every 100 μs.

As shown in FIG. 14, the method of flowchart 1400 begins at step 1402, in which PM control logic 702 determines if there are any valid entries in MBD table 722. As shown at decision step 1404, if PM control logic 702 determines that there is at least one valid entry, then PM control logic 702 will determine that the current test for power down eligibility has failed as shown at step 1406. The test fails because when any of the entries within MBD table 722 are designated valid, it is assumed that a corresponding frame is currently being processed by link layer logic 106 within DVB-H receiver 100. Thus, the components of DVB-H receiver 100 cannot be powered down while this condition holds true.

However, if PM control logic 702 determines at decision step 1404 that there are no valid entries in MBD table 722, then PM control logic 702 determines if there are any valid entries in delta-T table 724 as shown at step 1408. As shown at decision step 1410, if PM control logic 702 determines that there are no valid entries in delta-T table 724 then PM control logic 702 will determine that the current test for power down eligibility has failed as shown at step 1412.

However, if PM control logic 702 determines at decision step 1410 that there are one or more valid entries in delta-T table 724 then for each valid delta-T table entry, PM control logic 702 determines if an elapsed time since the delta-T value was set for that entry is less than or equal to the delta-T value less some minimum sleep time as shown at step 1414. In other words, PM control logic 702 determines for each valid delta-T entry whether or not:

current time−time indicated by entry time stamp<=delta-T value−minimum sleep time.

In one embodiment, PM control logic 702 determines the current time by obtaining a time stamp from a time stamp generator 726 and calculates elapsed time by subtracting the obtained time stamp from the entry time stamp. The elapsed time is then compared to the delta-T value less the minimum sleep time. The minimum sleep time represents a minimum amount of time that the power down state should be maintained to justify initiating the power down sequence. In some implementations, the minimum sleep time is a programmable parameter that is stored in configuration/status registers 706 and may be set by a host processor via host interface 704.

At decision step 1416, PM control logic 702 determines if the condition tested for during step 1414 is true for every valid delta-T table entry. If the condition is not true for every valid delta-T table entry, then PM control logic 702 will determine that the current test for power down eligibility has failed as shown at step 1418. This is because the time remaining until receipt of a time slice for at least one of the services represented by a valid entry in delta-T table 724 is too short to permit or justify powering down components of DVB-H receiver 100.

However, if PM control logic 702 determines at decision step 1416 that the condition tested for during step 1414 is true for every valid delta-T table entry, then PM control logic 702 will determine that the current test for power down eligibility has succeeded and will cause RF tuner 102, DVB-H demodulator 104 and the sub-blocks of link layer logic 106 to be powered down as shown at step 1420.

PM control logic 702 causes RF tuner 102 and DVB-H demodulator 104 to be powered down by sending power down signals to those components via RF tuner interface 708 and DVB-H demodulator interface 710, respectively, and causes TS packet filter 112, section manager 114, frame manager 116 and IP filter 118 to be powered down by gating a clock signal sent to those components via TS packet filter interface 712, section manager interface 714, frame manager interface 716, and IP filter interface 718, respectively.

In one implementation, PM control logic 702 does not immediately power down the sub-blocks of link layer logic 106 when eligibility for power down has been confirmed but instead sends a separate power down request signal to each of the sub-blocks. Responsive to receiving the power down request signal, each sub-block concludes any unfinished processing and performs other steps to ensure that it is in a proper state for power down. Once a sub-block is in a proper state for power down, it then sends a power down ready signal to PM control logic 702. Responsive to receiving the power down ready signal, PM control logic 702 then powers down the appropriate sub-block by gating the clock signal thereto. The foregoing approach is advantageous because it allows each sub-block of link layer logic 106 to determine whether it is ready for power down in parallel with the other sub-blocks, thereby reducing the overall time necessary to perform such functions. This approach is also advantageous because it allows sub-blocks that achieve the proper state for power down earlier than other sub-blocks to be powered down as soon as such state is achieved, rather than waiting for the other sub-blocks.

Since PM control logic 702 is capable of independently powering down RF tuner 102, DVB-H demodulator 104 and each of the sub-blocks of link layer logic 106, an embodiment of the present invention may be configured to determine power down eligibility for each of these components based on different criteria and then execute power down for each component at different times. For example, in one embodiment of the present invention, a different minimum sleep time is maintained for each of RF tuner 102, DVB-H demodulator 104 and link layer logic 106 and a different power down eligibility test is performed for each of these components based on the different sleep times. These different minimum sleep times may be programmable parameters that is stored in configuration/status registers 706 and may be set by a host processor via host interface 704.

Although in the embodiment described above, PM control logic 702 is described as initiating power down through the transmission of signals to RF tuner 102, DVB-H demodulator 104 and the sub-blocks of link layer logic 106, in an alternate embodiment of the present invention, a host processor may be used to power down these components responsive to interrupt signals generated by PM control logic 702. These interrupts may be generated responsive to the setting of certain status registers within configuration/status registers 706 by PM control logic 702.

4. Power-up Determination and Execution

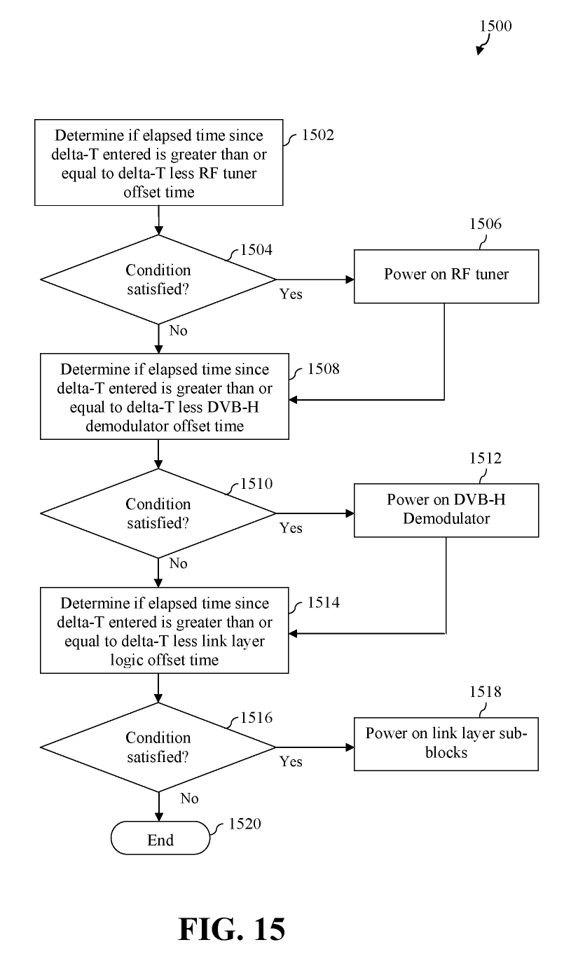

Once PM control logic 702 has placed components of DVB-H receiver 100 in a power down state, it must then determine when such components should be powered up so that DVB-H receiver 100 is fully operational to receive bursts associated with requested services. The manner in which PM control logic 702 performs this function will now be described in reference to flowchart 1500 of FIG. 15. PM control logic 702 periodically performs the test for power up represented by flowchart 1500 for each valid entry in delta-T table 724. In one implementation, PM control logic 702 performs the test for each valid entry in delta-T table 724 every 100 μs.

As shown in FIG. 15, the method of flowchart 1500 begins at step 1502, in which PM control logic 702 determines if an elapsed time since a delta-T value was set for an entry in delta-T table 724 is greater than or equal to the delta-T value less an RF tuner offset time as shown at step 1502. In other words, PM control logic 702 determines whether or not:

current time−time indicated by entry time stamp>=delta-T value−RF tuner offset time.

In one embodiment, PM control logic 702 determines the current time by obtaining a time stamp from a time stamp generator 726 and calculates elapsed time by subtracting the obtained time stamp from the entry time stamp. The elapsed time is then compared to the delta-T value less the RF tuner offset time. The RF tuner offset time represents an amount of time that RF tuner 102 should to be powered up in advance of receiving a burst. In some implementations, the RF tuner offset time is a programmable parameter that is stored in configuration/status registers 706 and may be set by a host processor via host interface 704.

At decision step 1504, PM control logic 702 determines if the condition tested for during step 1502 is true for the current delta-T table entry. If the condition is true for the current delta-T table entry, then PM control logic 702 will cause RF tuner 102 to be powered on as shown at step 1506 and then processing will proceed to step 1508. PM control logic 702 may cause RF tuner 102 to be powered on by sending a power on signal to RF tuner 102 via RF tuner interface 708. Alternatively, PM control logic 702 may cause RF tuner 102 to be powered on by generating an interrupt to a host processor, which operates to power on RF tuner 102 responsive to the interrupt. The interrupt signal may be generated responsive to the setting of certain status registers within configuration/status registers 706 by PM control logic 702

However, if PM control logic 702 determines at decision step 1504 that the condition tested for during step 1502 is not true for the current delta-T table entry, then PM control logic 702 will immediately perform step 1508. During step 1508, PM control logic 702 determines if an elapsed time since a delta-T value was set for the entry in delta-T table 724 is greater than or equal to the delta-T value less a DVB-H demodulator offset time. In other words, PM control logic 702 determines whether or not:

current time−time indicated by entry time stamp>=delta-T value−DVB-H demodulator offset time.

In one embodiment, PM control logic 702 determines the current time by obtaining a time stamp from a time stamp generator 726 and calculates elapsed time by subtracting the obtained time stamp from the entry time stamp. The elapsed time is then compared to the delta-T value less the DVB-H demodulator offset time. The DVB-H demodulator offset time represents an amount of time that DVB-H demodulator 104 should be powered up in advance of receiving a burst. In some implementations, the DVB-H demodulator offset time is a programmable parameter that is stored in configuration/status registers 706 and may be set by a host processor via host interface 704.

At decision step 1510, PM control logic 702 determines if the condition tested for during step 1508 is true for the current delta-T table entry. If the condition is true for the current delta-T table entry, then PM control logic 702 will cause DVB-H demodulator 104 to be powered on as shown at step 1512 and then processing will proceed to step 1514. PM control logic 702 may cause DVB-H demodulator 104 to be powered on by sending a power on signal to DVB-H demodulator 104 via DVB-H demodulator interface 710. Alternatively, PM control logic 702 may cause DVB-H demodulator 104 to be powered on by generating an interrupt to a host processor. The interrupt signal may be generated responsive to the setting of certain status registers within configuration/status registers 706 by PM control logic 702.

However, if PM control logic 702 determines at decision step 1510 that the condition tested for during step 1508 is not true for the current delta-T table entry, then PM control logic 702 will immediately perform step 1514. During step 1514, PM control logic 702 determines if an elapsed time since a delta-T value was set for the entry in delta-T table 724 is greater than or equal to the delta-T value less a link layer logic offset time. In other words, PM control logic 702 determines whether or not:

current time−time indicated by entry time stamp>=delta-T value−link layer logic offset time.

In one embodiment, PM control logic 702 determines the current time by obtaining a time stamp from a time stamp generator 726 and calculates elapsed time by subtracting the obtained time stamp from the entry time stamp. The elapsed time is then compared to the delta-T value less the link layer logic offset time. The link layer logic offset time represents an amount of time that the sub-blocks of link layer logic 106 should be powered up in advance of receiving a burst. In some implementations, the link layer logic offset time is a programmable parameter that is stored in configuration/status registers 706 and may be set by a host processor via host interface 704.

At decision step 1516, PM control logic 702 determines if the condition tested for during step 1514 is true for the current delta-T table entry. If the condition is true for the current delta-T table entry, then PM control logic 702 will cause the sub-blocks of link layer logic 106 to be powered on as shown at step 1518. PM control logic 702 may cause the sub-blocks of link layer logic 106 to be powered on by supplying a respective clock signal to each of the sub-blocks. Alternatively, PM control logic 702 may cause each of the sub-blocks of link layer logic 106 to be powered on by generating an interrupt to a host processor. The interrupt signal may be generated responsive to the setting of certain status registers within configuration/status registers 706 by PM control logic 702.

However, if PM control logic 702 determines at decision step 1516 that the condition tested for during step 1508 is not true for the current delta-T table entry, then the power up test for that delta-T table entry ends as shown at step 1520.

The foregoing approach to power up advantageously allows RF tuner 102, DVB-H demodulator 104 and the sub-blocks of link layer logic 106 to be powered up at separate times based on the RF tuner offset, DVB-H demodulator offset and link layer logic offset parameter values. This allows the power up functionality to take into account the different amounts of time needed to power up each of these components. In one implementation, these components are powered up in a staggered fashion such that RF tuner 102 is powered up first, DVB-H demodulator 104 is powered up second and link layer logic 106 is powered up third. By powering up each component only when absolutely necessary to do so, an embodiment of the present invention reduces the average power consumption of DVB-H receiver 100.

5. Example Interface Implementations

A description of one manner of implementing the interfaces between power manager 108 and RF tuner 102, DVB-H demodulator 104, and the various sub-blocks of link layer logic 106 will now be provided. These implementation details are provided by way of example and are not intended to limit the present invention.

RF tuner interface 708 is configured to transmit a one-bit power down request signal to RF tuner 104. This signal is set forth in Table 8 below.

TABLE 8
Signal Output from Power Manager to RF Tuner

| Signal Name | Pins | Active |
|---|---|---|
| tuner_pd_req | 1 | High |

DVB-H demodulator interface 710 is configured to transmit a one-bit power down request signal to DVB-H demodulator 104. This signal is set forth in Table 9 below.

TABLE 9
Signal Output from Power Manager to DVB-H Demodulator

| Signal Name | Pins | Active |
|---|---|---|
| demod_pd_req | 1 | High |

Section manager interface 714 is configured to transmit and receive signals to and from section manager 114. The signals transmitted to section manager 114 in accordance with one implementation of the present invention are set forth in Table 10 below. Each of these signals will now be described.

TABLE 10
Signals Output from Power Manager to Section Manager

| Signal Name | Pins | Active |
|---|---|---|
| pm_entry_gnt | 1 | High |
| pm_mbd_req | 1 | High |
| pm_mbd_ptr [4:0] | 5 | N/A |
| sm_pd_req | 1 | High |
| o_sm_clk | 1 | clk |

The signal pm_entry_gnt is asserted to indicate that a request from section manager 114 to update a delta-T value or set or clear an MBD entry has been granted.

The signal pm_mbd_req is asserted to indicate that an MBD timer has expired for a frame associated with a particular service.

The signal pm_mbd_ptr [4:0] is a 5-bit pointer that is used to indicate for which of 32 requested services an MBD timer has expired.

The signal sm_pd_req is asserted to issue a power down request to section manager 114.

The signal o_sm_clk is the main clock signal used by section manager 114. This clock signal is gated by power manager 108 to place section manager 114 in a power down mode.

The signals received from section manager 114 via section manager interface 714 in accordance with one implementation of the present invention are set forth in Table 11 below. Each of these signals will now be described.

TABLE 11
Signals Input to Power Manager from Section Manager

| Signal Name | Pins | Active |
|---|---|---|
| sm_entry_req | 1 | High |
| sm_dt_mbd | 1 | High |
| sm_dt_v [12:0] | 13 | N/A |
| sm_dt_ptr [4:0] | 5 | N/A |
| sm_mbd_set | 1 | High |
| sm_mbd_gnt | 1 | High |
| sm_pd_rdy | 1 | High |

The signal sm_entry_req is asserted to request that a delta-T value be updated or that an MBD entry be set or cleared.

The signal sm_dt_mbd is used to indicate the request type associated with the assertion of sm_entry_req. When sm_dt_mbd is “0”, the request is to update a delta-T value. When sm_dt_mbd is “1”, the request is to set or clear an MBD entry.

The signal sm_dt_v [12:0] is used to carry a 13-bit delta-T value output for updating by section manager 114. This signal is valid when sm_entry req is asserted and sm_dt_mbd is set to “0”.

The signal sm_dt_ptr [4:0] is a 5-bit pointer that is used to identify which of 32 requested services sm_entry_req has been asserted for.

The signal sm_mbd_set is used to indicate if the request associated with the assertion of sm_entry_req is for setting an MBD entry or for clearing an MBD entry. This signal is valid when sm_entry_req is asserted and sm_dt_mbd is set to “1”.

The signal sm_mbd_gnt is asserted to indicate that an MBD timer expiration (as signaled by power manager 108 using pm_mbd_req) has been processed by section manager 114.

The signal sm_pd_rdy is asserted to indicate when section manager 114 is ready to be powered down in response to receiving the signal sm_pd_req from power manager 108.

TS packet filter interface 712 is configured to transmit and receive signals to and from TS packet filter 112. The signals transmitted to TS packet filter 112 in accordance with one implementation of the present invention are set forth in Table 12 below. Each of these signals will now be described.

TABLE 12
Signals Output from Power Manager to TS Packet Filter

| Signal Name | Pins | Active |
|---|---|---|
| pf_pd_req | 1 | High |
| o_pf_clk | 1 | clk |

The signal pf_pd_req is asserted to issue a power down request to TS packet filter 112.

The signal o_pf_clk is the main clock signal used by TS packet filter 112. This clock signal is gated by power manager 108 to place TS packet filter 112 in a power down mode.

In one implementation, power manager 108 also transmits an indication to TS packet filter 112 of which of 32 requested services should currently be receiving packets based on the delta-T information maintained in delta-T table 722. For example, power manager 108 may transmit a 32-bit signal to TS packet filter 112, wherein each bit represents one of the 32 requested services and wherein a bit set to “1” only if packets are currently expected for the corresponding service. TS packet filter 112 can advantageously use this information to identify and discard undesired TS packets or TS packets with incorrect PIDs due to transmission errors or the like.

The signal received from TS packet filter 112 via TS packet filter interface 712 in accordance with one implementation of the present invention is set forth in Table 13 below. This signal, pf_pd_rdy, is asserted to indicate when TS packet filter 112 is ready to be powered down in response to receiving the signal pf_pd_req from power manager 108.

TABLE 13
Signal Input to Power Manager from TS Packet Filter

| Signal Name | Pins | Active |
|---|---|---|
| pf_pd_rdy | 1 | High |

Frame manager interface 716 is configured to transmit and receive signals to and from frame manager 116. The signals transmitted to frame manager 116 in accordance with one implementation of the present invention are set forth in Table 14 below. Each of these signals will now be described.

TABLE 14
Signals Output from Power Manager to Frame Manager

| Signal Name | Pins | Active |
|---|---|---|
| fm_pd_req | 1 | High |
| o_fm_clk | 1 | clk |

The signal fm_pd_req is asserted to issue a power down request to frame manager 116.

The signal o_fm_clk is the main clock signal used by frame manager 116. This clock signal is gated by power manager 108 to place frame manager 116 in a power down mode.

The signal received from frame manager 116 via frame manager interface 716 in accordance with one implementation of the present invention is set forth in Table 15 below. This signal, fm_pd_rdy, is asserted to indicate when frame manager 116 is ready to be powered down.

TABLE 15
Signal Input to Power Manager from Frame Manager

| Signal Name | Pins | Active |
|---|---|---|
| fm_pd_rdy | 1 | High |

IP filter interface 718 is configured to transmit and receive signals to and from IP filter 118. The signals transmitted to IP filter 118 in accordance with one implementation of the present invention are set forth in Table 16 below. Each of these signals will now be described.

TABLE 16
Signals Output from Power Manager to IP Filter

| Signal Name | Pins | Active |
|---|---|---|
| ipf_pd_req | 1 | High |
| o_ipf_clk | 1 | clk |

The signal ipf_pd_req is asserted to issue a power down request to IP filter 118.

The signal o_ipf_clk is the main clock signal used by IP filter 118. This clock signal is gated by power manager 108 to place IP filter 118 in a power down mode.

The signal received from IP filter 118 via IP filter interface 718 in accordance with one implementation of the present invention is set forth in Table 17 below. This signal, ipf_pd_rdy, is asserted to indicate when IP filter 118 is ready to be powered down.

TABLE 17
Signal Input to Power Manager from Frame Manager

| Signal Name | Pins | Active |
|---|---|---|
| ipf_pd_rdy | 1 | High |

### III. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A hardware-implemented video broadcasting receiver, comprising:
a radio frequency (RF) tuner configured to receive bursts of RF signals and to convert the RF signals into in-phase (I) and quadrature (Q) signal components;
a demodulator connected to the RF tuner, the demodulator configured to convert the I and Q signal components into a transport stream;
link layer logic connected to the demodulator, the link layer logic configured to generate a series of Internet Protocol (IP) packets from the transport stream and to extract delta-T values therefrom, each delta-T value being representative of an amount of time from a beginning of a section carried by the transport stream to receipt of a next burst by the video broadcasting receiver; and
a power manager connected to the RF tuner, the demodulator and the link layer logic, the power manager configured to receive the delta-T values from the link layer logic, to determine whether each of the RF tuner, the demodulator and the link layer logic can be powered down based on the delta-T values, and to power down the RF tuner, the demodulator and the link layer logic based on the determination.

2. The receiver of claim 1, wherein the power manager is configured to power down the RF tuner, the demodulator and the link layer logic by transmitting respective power down signals to the RF tuner, the demodulator and the link layer logic.

3. The receiver of claim 1, wherein the power manager is configured to power down the RF tuner, the demodulator and the link layer logic by generating interrupts to a host processor, wherein the host processor is configured to power down the RF tuner, the demodulator and the link layer logic responsive to receiving the interrupts.

4. The receiver of claim 1, wherein the link layer logic comprises a plurality of sub-blocks and wherein the power manager is configured to power down the link layer logic by gating a respective clock signal to each sub-block in the plurality of sub-blocks.

5. The receiver of claim 4, wherein the power manager is configured to gate a respective clock signal to each sub-block in the plurality of sub-blocks responsive to sending a respective power down request signal to each sub-block in the plurality of sub-blocks and subsequently receiving a respective power down ready signal from each sub-block in the plurality of sub-blocks.

6. The receiver of claim 1, wherein the power manager is configured to store a respective delta-T value for each service in a plurality of services, and
wherein the power manager is configured to determine whether each of the RF tuner, the demodulator and the link layer logic can be powered down by determining, for each service in the plurality of services, if an amount of time that has elapsed since receiving the delta-T value for the service is less than an amount of time represented by the delta-T for the service less a minimum sleep time.

7. The receiver of claim 1, wherein the power manager is configured to determine whether the link layer logic is processing any frames carried by the transport stream and associated with a requested service and to determine whether each of the RF tuner, the demodulator and the link layer logic can be powered down responsive to determining that the link layer logic is not processing any frames carried by the transport stream and associated with a requested service.

8. The receiver of claim 7, wherein the power manager is configured to determine whether the link layer logic is processing any frames carried by the transport stream and associated with a requested service by monitoring signals from the link layer logic indicating that an end of a frame has been received.

9. The receiver of claim 8, wherein the power manager is further configured to determine whether the link layer logic is processing any frames carried by the transport stream and associated with a requested service by monitoring signals from the link layer logic indicating that an end of an application data table portion of a frame has been received.

10. The receiver of claim 7, wherein the power manager is configured to determine whether the link layer logic is processing any frames carried by the transport stream and associated with a requested service by monitoring whether a maximum burst duration associated with a frame currently being processed by the link layer logic has been exceeded.

11. The receiver of claim 1, wherein the power manager is further configured to determine when each of the RF tuner, the demodulator and the link layer logic should be powered up based on the delta-T values.

12. The receiver of claim 11, wherein the power manager is configured to store a respective delta-T value for each service in a plurality of services, and
wherein the power manager is configured to determine when the RF tuner should be powered up by determining, for each service in the plurality of services, if an amount of time that has elapsed since receiving the delta-T value for the service is less than an amount of time represented by the delta-T value for the service less an offset time associated with the RF tuner,
wherein the power manager is configured to determine when the demodulator should be powered up by determining, for each service in the plurality of services, if an amount of time that has elapsed since receiving the delta-T value for the service is less than an amount of time represented by the delta-T value for the service less an offset time associated with the demodulator, and
wherein the power manager is configured to determine when the link layer logic should be powered up by determining, for each service in the plurality of services, if an amount of time that has elapsed since receiving the delta-T value for the service is less than an amount of time represented by the delta-T value for the service less an offset time associated with the link layer logic.

13. The receiver of claim 1, wherein the link layer logic is configured to extract delta-T values from consecutive sections in a plurality of frames carried by the transport stream, and
wherein the power manager is configured to determine whether each of the RF tuner, the demodulator and the link layer logic can be powered down based on delta-T values respectively associated with the most-recently processed sections in each frame in the plurality of frames.

14. The receiver of claim 1, wherein the power manager is configured to identify one or more services for which packets should be received within the transport stream based on the delta-T values and to transmit signals to the link layer logic that identify the one or more services, and
wherein the link layer logic is configured to filter packets within the transport stream based on the signals transmitted from the power manager.

15. A method for performing power management in a hardware-implemented video broadcasting receiver, comprising:
receiving bursts of radio frequency (RF) signals and converting the RF signals into in-phase (I) and quadrature (Q) signal components in an RF tuner;
converting the I and Q signal components into a transport stream in a demodulator;
generating a series of Internet Protocol (IP) packets from the transport stream and extracting delta-T values therefrom in link layer logic, each delta-T value being representative of an amount of time from a beginning of a section carried by the transport stream to receipt of a next burst by the video broadcasting receiver; and
receiving the delta-T values from the link layer logic;
determining whether each of the RF tuner, the demodulator and the link layer logic can be powered down based on the delta-T values; and
powering down the RF tuner, the demodulator and the link layer logic based on the determination.

16. The method of claim 15, wherein powering down the RF tuner, the demodulator and the link layer logic comprises transmitting respective power down signals to the RF tuner, the demodulator and the link layer logic.

17. The method of claim 15, wherein powering down the RF tuner, the demodulator and the link layer logic comprises generating interrupts to a host processor, wherein the host processor is configured to power down the RF tuner, the demodulator and the link layer logic responsive to receiving the interrupts.

18. The method of claim 15, wherein powering down the link layer logic comprises gating a respective clock signal to each sub-block in a plurality of sub-blocks within the link layer logic.

19. The method of claim 18, further comprising:
sending a respective power down request signal to each sub-block in the plurality of sub-blocks; and
receiving a respective power down ready signal from each sub-block in the plurality of sub-blocks;
wherein gating a respective clock signal to each sub-block in the plurality of sub-blocks comprises gating a respective clock signal to each sub-block in the plurality of sub-blocks responsive to receiving a respective power down ready signal from each sub-block in the plurality of sub-blocks.

20. The method of claim 15, further comprising:
storing a respective delta-T value for each service in a plurality of services;
wherein determining whether each of the RF tuner, the demodulator and the link layer logic can be powered down comprises determining, for each service in the plurality of services, if an amount of time that has elapsed since receiving the extracted delta-T value for the service is less than an amount of time represented by the delta-T for the service less a minimum sleep time.

21. The method of claim 15, further comprising:
determining whether the link layer logic is processing any frames carried by the transport stream and associated with a requested service;
wherein determining whether each of the RF tuner, the demodulator and the link layer logic can be powered down comprises determining whether each of the RF tuner, the demodulator and the link layer logic can be powered down responsive to determining that the link layer logic is not processing any frames carried by the transport stream and associated with a requested service.

22. The method of claim 21, wherein determining whether the link layer logic is processing any frames carried by the transport stream and associated with a requested service comprises:
monitoring signals from the link layer logic indicating that an end of a frame has been received.

23. The method of claim 22, wherein determining whether the link layer logic is processing any frames carried by the transport stream and associated with a requested service further comprises:
monitoring signals from the link layer logic indicating that an end of an application data table portion of a frame has been received.

24. The method of claim 21, wherein determining whether the link layer logic is processing any frames carried by the transport stream and associated with a requested service comprises:
monitoring whether a maximum burst duration associated with a frame currently being processed by the link layer logic has been exceeded.

25. The method of claim 15, further comprising:
determining when each of the RF tuner, the demodulator and the link layer logic should be powered up based on the delta-T values.

26. The method of claim 25, further comprising:
storing a respective delta-T value for each service in a plurality of services; and
wherein determining when the RF tuner should be powered up comprises determining, for each service in the plurality of services, if an amount of time that has elapsed since receiving the delta-T value for the service is less than an amount of time represented by the delta-T value for the service less an offset time associated with the RF tuner,
wherein determining when the demodulator should be powered comprises determining, for each service in the plurality of services, if an amount of time that has elapsed since receiving the delta-T value for the service is less than an amount of time represented by the delta-T value for the service less an offset time associated with the demodulator, and
wherein determining when the link layer logic should be powered up comprises determining, for each service in the plurality of services, if an amount of time that has elapsed since receiving the delta-T value for the service is less than an amount of time represented by the delta-T value for the service less an offset time associated with the link layer logic.

27. The method of claim 15, wherein extracting delta-T values from the transport stream comprises extracting delta-T values from consecutive sections in a plurality of frames carried by the transport stream, and
wherein determining whether each of the RF tuner, the demodulator and the link layer logic can be powered down based on the delta-T values comprises determining whether each of the RF tuner, the demodulator and the link layer logic can be powered down based on the delta-T values respectively associated with the most-recently processed sections in each of the plurality of frames.

28. The method of claim 15, further comprising:
identifying one or more services for which packets should be received within the transport stream based on the delta-T values;
transmitting signals to the link layer logic that identify the one or more services; and
filtering packets within the transport stream in the link layer logic based on the transmitted signals.
